(19) United States
(12) Patent Application Publication
(10) Pub. No.: US 2015/0002518 A1
(43) Pub. Date: Jan. 1, 2015

(54) IMAGE GENERATING APPARATUS

(71) Applicant: CASIO COMPUTER CO., LTD., Tokyo (JP)

(72) Inventor: Mitsuyasu NAKAJIMA, Tokyo (JP)

(21) Appl. No.: 14/310,812

(22) Filed: Jun. 20, 2014

(30) Foreign Application Priority Data
Jun. 27, 2013 (JP) 2013-135615

(51) Int. Cl. G06T 13/80

(52) U.S. Cl. CPC G06T 13/80
USPC 345/474

(57) ABSTRACT

An image generating apparatus (100) includes an animation acquiring unit (150) that acquires a plurality of items of animation data. A terminal apparatus (200) includes an index value acquiring unit (251), a composite skeleton generating unit (252), and a drawing processing unit (253). The index value acquiring unit (251) inputs an index value regarding a motion of animation data, and the composite skeleton generating unit (252) generates animation data according to the index value input by the index value acquiring unit (251), using the plurality of items of animation data acquired by the animation acquiring unit (150).

This application is based on and claims the benefit of priority from Japanese Patent Application No. 2013-135615, filed on 27 Jun. 2013, the content of which is incorporated herein by reference.

### BACKGROUND OF THE INVENTION

1. Field of the Invention

The present invention relates to an image generating apparatus for generating animation data, an image generating method, and a storage medium.

2. Related Art

Conventionally, Japanese Unexamined Patent Application Publication No. 2012-248233 describes technology, in which a plurality of markers are set for a person and motions of the respective markers are measured to acquire animation data.

### SUMMARY OF THE INVENTION

To achieve the object, an image generating apparatus of one aspect of the present invention includes:

a data acquiring unit for acquiring a plurality of items of animation data; an input unit for inputting an index value regarding a motion of animation data; and a first generating unit for generating animation data according to the index value input by the input unit, using the plurality of items of animation data acquired by the data acquiring unit. Further, to achieve the object, an image generating method of one aspect of the present invention includes the steps of:

acquiring a plurality of items of animation data; inputting an index value regarding a motion of animation data; and generating animation data according to the index value input in the input step, using the plurality of items of animation data acquired in the data acquiring step. Further, to achieve the object, a storage medium of one aspect of the present invention is

a non-transitory storage medium encoded with a computer-readable program that enables a computer to execute functions as a data acquiring unit for acquiring a plurality of items of animation data; an input unit for inputting an index value regarding a motion of animation data, and a generating unit for generating animation data according to the index value input by the input unit, using the plurality of items of animation data acquired by the data acquiring unit.

### BRIEF DESCRIPTION OF THE DRAWINGS

FIG. 1 illustrates a configuration of an image generating system according to one embodiment of the present invention;

FIG. 2 is a block diagram illustrating a hardware configuration of an image generating apparatus according to one embodiment of the present invention;

FIG. 3 is a block diagram illustrating a hardware configuration of a terminal apparatus according to one embodiment of the present invention;

FIG. 4 is a function block diagram illustrating a functional configuration for executing preparation processing among the functional configurations of the image generating apparatus;

FIG. 5 is a schematic view illustrating an outline of a skeleton;

FIG. 6 is a function block diagram illustrating a functional configuration for executing skeleton drawing processing among the functional configurations of the terminal apparatus;

FIG. 7 is a flowchart illustrating one example of a flow of preparation processing executed by the image generating apparatus of FIG. 2 having the functional configuration of FIG. 4;

FIG. 8 is a flowchart illustrating one example of a flow of normalized skeleton acquisition processing in the preparation processing;

FIG. 9 is a flowchart illustrating one example of a flow of standard skeleton acquisition processing in the preparation processing;

FIG. 10 is a flowchart illustrating one example of a flow of index association processing in the preparation processing;

FIG. 11 is a flowchart illustrating one example of a flow of axis parameter determination processing in the preparation processing;

FIG. 12 is a flowchart illustrating one example of a flow of skeleton drawing processing executed by the terminal apparatus of FIG. 3 having the functional configuration of FIG. 6;

FIG. 13 is a schematic view illustrating a display screen example displayed by skeleton drawing processing;

FIG. 14 is a flowchart illustrating one example of a flow of composite skeleton generation processing in the skeleton drawing processing;

FIG. 15 is a schematic view illustrating a time-series skeleton space;

FIG. 16 is a schematic view illustrating a skeleton space of a frame (frame number=k) different from that in FIG. 15;

FIG. 17A is a schematic view illustrating a composite skeleton in a skeleton space, being a view illustrating a state where a standard skeleton motion is set in the skeleton space;

FIG. 17B is a schematic view illustrating a composite skeleton in a skeleton space, being a view illustrating skeleton motions according to index values regarding different motions;

FIG. 17C is a schematic view illustrating a composite skeleton in a skeleton space, being a view illustrating a composite skeleton;

FIG. 18 is a flowchart illustrating a flow of first arrow drawing processing executed by the terminal apparatus of FIG. 3 having the functional configuration of FIG. 5;

FIG. 19 is a view illustrating a state where a skeleton is repeatedly drawn;

FIG. 20 is a schematic view illustrating a display screen example where a viewing point direction has been changed;

FIG. 21 is a schematic view illustrating a display screen example at a time different from that in FIG. 20;

FIG. 22 is a flowchart illustrating a flow of second arrow drawing processing executed by the terminal apparatus of FIG. 3 having the functional configuration of FIG. 5;

FIG. 23 is a view illustrating a state where a skeleton is repeatedly drawn;

FIG. 24 is a schematic view illustrating a display screen example where an arrow indicating a changing direction of a site of a skeleton is displayed;

FIG. 25 is a flowchart illustrating a flow of index reporting processing executed by the terminal apparatus of FIG. 3 having the functional configuration of FIG. 5;

FIG. 26 is a schematic view illustrating a display screen example of a skeleton a movable joint of which is drawn larger than other joints;

FIG. 27 is a flowchart illustrating a flow of movement processing executed as interruption processing in the index reporting processing;

FIG. 28 is a flowchart illustrating a flow of end interruption processing executed as interruption processing in index reporting processing and movement processing; and

FIG. 29 is a flowchart illustrating a flow of real-time display processing executed by the terminal apparatus of FIG. 3 having the functional configuration of FIG. 5.

### DETAILED DESCRIPTION OF THE INVENTION

Embodiments of the present invention will now be described with reference to the drawings.

The image generating system according to the present embodiment acquires a plurality of items of motion capture data including human motions by detecting positions of markers placed on a person serving as a model and acquires, based on these, a skeleton motion (a motion of the model expressed by a bone structure formed of “bones” and “joints”) as a standard. Further, the image generating system according to the present embodiment sets an index value (e.g., a value of a maximum kick acceleration) regarding a motion for a standard skeleton motion and sets an axis parameter regarding this index. A specific value of an index regarding a motion is set based on a plurality of skeleton motions or a parameter of a motion (e.g., a kick acceleration value) measured in conjunction with motion capture data acquisition. Further, the axis parameter is a value indicating a degree of a motion set based on a distribution of respective index values in a plurality of skeleton motions. Then, when the user inputs a change in an index value regarding a motion, a standard skeleton motion is changed in accordance with the axis parameter. The changed skeleton motion is displayed so that a changed portion from the standard skeleton motion is discriminated.

This makes it possible to change a skeleton obtained by measuring a motion to a desired motion.

Further, the axis parameter is acquired based on a plurality of skeletons. Therefore, when a motion is changed in accordance with the axis parameter, a change in a standard skeleton motion becomes based on a human motion, resulting in a possibility of realization of a more appropriate motion change.

Further, it is possible to present a portion where the standard skeleton motion has been changed to the user in an easily understandable manner.

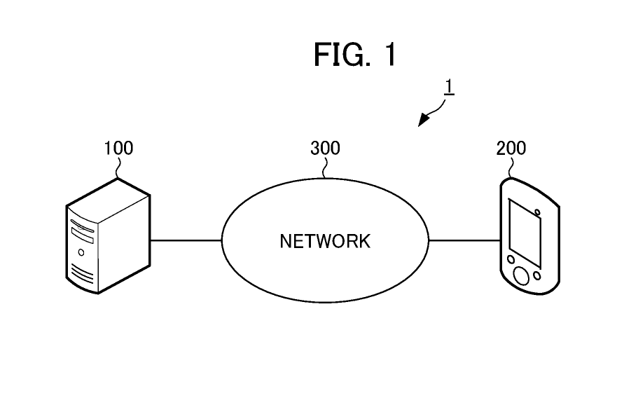

FIG. 1 illustrates a configuration of an image generating system 1 according to one embodiment of the present invention.

In FIG. 1, the image generating system 1 includes an image generating apparatus 100 and a terminal apparatus 200, and the image generating apparatus 100 and the terminal apparatus 200 are communicably configured via a network 300 such as the Internet.

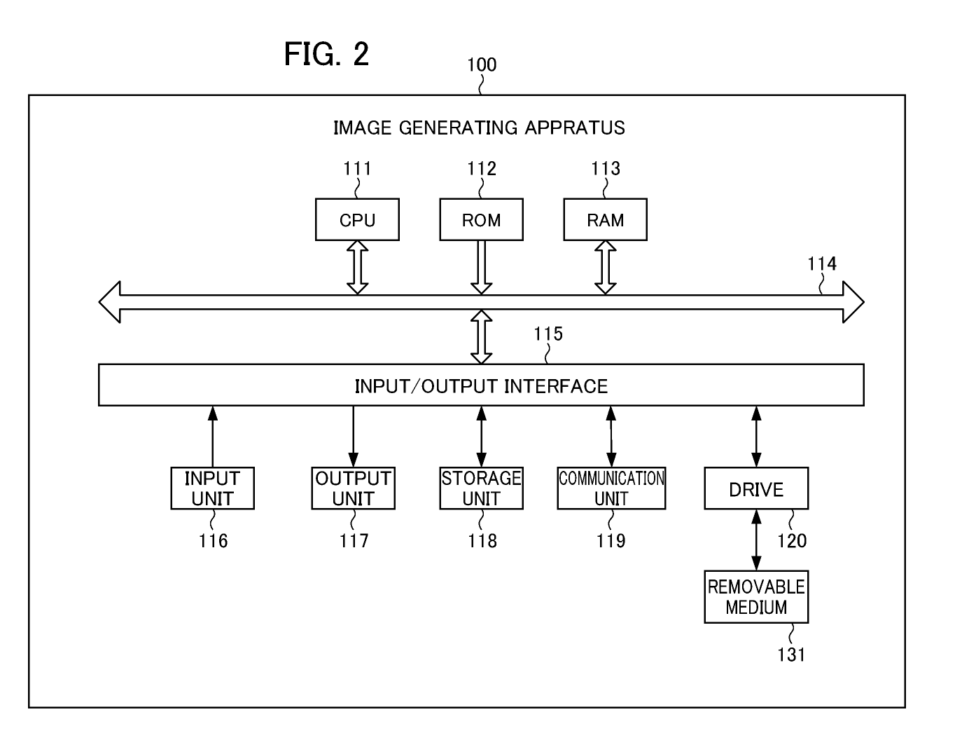

FIG. 2 is a block diagram illustrating a hardware configuration of the image generating apparatus 100 according to one embodiment of the present invention.

The image generating apparatus 100 is configured using, for example, a server.

The image generating apparatus 100 includes a CPU (Central Processing Unit) 111, a ROM (Read Only Memory) 112, a RAM (Random Access Memory) 113, a bus 114, an input/output interface 115, an input unit 116, an output unit 117, a storage unit 118, a communication unit 119, and a drive 120.

The CPU 111 executes a variety of processing in accordance with programs recorded on the ROM 112 or programs loaded on the RAM 113 from the storage unit 118 such as a program for preparation processing (to be described later).

The RAM 113 also stores data and the like necessary for the CPU 111 to execute a variety of processing, as appropriate.

The CPU 111, the ROM 112, and the RAM 113 are connected to each other via the bus 114. This bus 114 is also connected to the input/output interface 115. The input/output interface 115 is connected to the input unit 116, the output unit 117, the storage unit 118, the communication unit 119, and the drive 120.

The input unit 116 includes a variety of buttons and others, and inputs various pieces of information according to an instruction operation of the user.

The output unit 117 includes a display, a speaker, and others, and outputs an image and a voice.

The storage unit 118 includes a hard disk, a DRAM (Dynamic Random Access Memory), or the like, and stores skeleton data and data of index values regarding motions, axis parameters, and the like.

The communication unit 119 controls communications with other apparatuses via a network including the Internet.

The drive 120 is mounted with a removable medium 131 configured using a magnetic disk, an optical disk, a magneto-optical disk, a semiconductor memory, or the like, as appropriate. A program read from the removable medium 131 by the drive 120 is installed on the storage unit 118, as necessary. Further, the removable medium 131 can also store a variety of data such as image data stored on the storage unit 118 in the same manner as the storage unit 118.

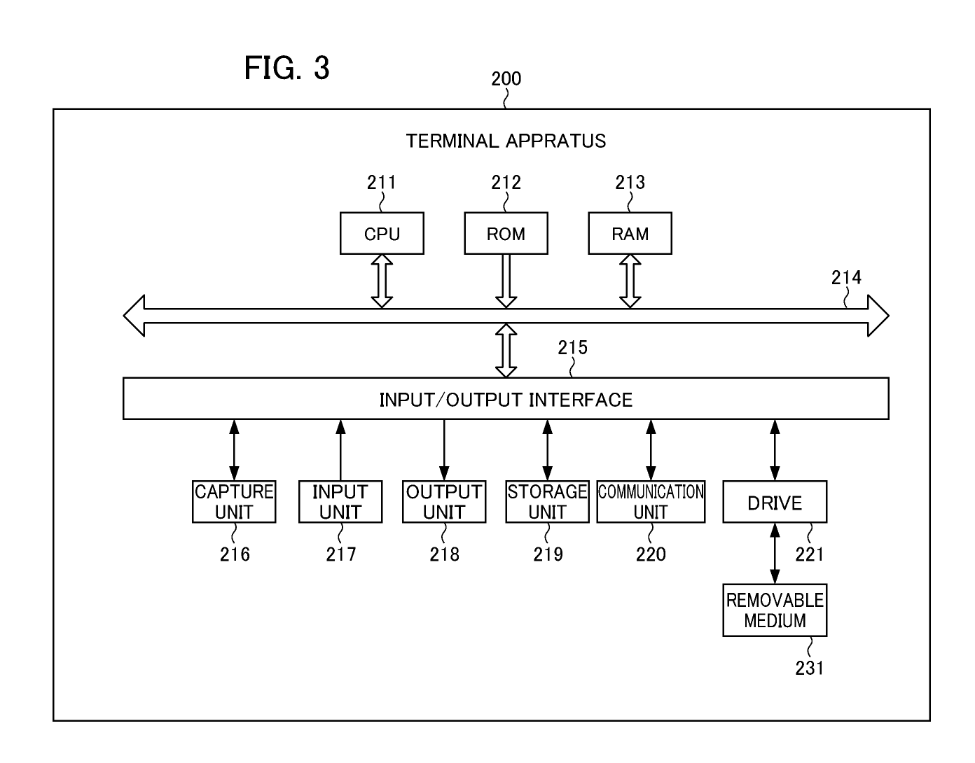

FIG. 3 is a block diagram illustrating a hardware configuration of the terminal apparatus 200 according to one embodiment of the present invention.

The terminal apparatus 200 is configured using a mobile terminal referred to as a smartphone, for example.

In FIG. 3, the terminal apparatus 200 includes a CPU 211, a ROM 212, a RAM 213, a bus 214, an input/output interface 215, an image capture unit 216, an input unit 217, an output unit 218, a storage unit 219, a communication unit 220, and a drive 221.

The CPU 211 executes a variety of processing in accordance with programs recorded on the ROM 212 or programs loaded on the RAM 213 from the storage unit 219 such as a program for skeleton drawing processing.

The RAM 213 also stores data and the like necessary for the CPU 211 to execute a variety of processing, as appropriate.

The CPU 211, the ROM 212, and the RAM 213 are connected to each other via the bus 214. This bus 214 is also connected to the input/output interface 215. The input/output interface 215 is connected to the image capture unit 216, the input unit 217, the output unit 218, the storage unit 219, the communication unit 220, and the drive 221.

The image capture unit 216 includes an optical lens unit and an image sensor which are not illustrated.

In order to photograph a subject, the optical lens unit includes a lens such as a focus lens and a zoom lens for condensing light.

The focus lens is a lens for forming a subject image on the light receiving surface of the image sensor.

The zoom lens is a lens that causes the focal length to freely change in a certain range.

The optical lens unit also includes a peripheral circuit for adjusting setting parameters such as focus, exposure, and white balance, as necessary.

The image sensor includes a photoelectric conversion device, an AFE (Analog Front End), and others.

The photoelectric conversion device is configured using, for example, a photoelectric conversion device of a CMOS (Complementary Metal Oxide Semiconductor) type. A subject image from the optical lens unit enters the photoelectric conversion device. The photoelectric conversion device photoelectrically converts (image-captures) the subject image, accumulates the resultant image signal for a certain period of time, and sequentially supplies the accumulated image signal to the AFE as an analog signal.

The AFE executes a variety of signal processing such as A/D (Analog/Digital) conversion processing for the analog image signal. The variety of signal processing generates a digital signal that is output as an output signal (data of the captured image) of the image capture unit 216.

The input unit 217 includes a variety of buttons and others, and inputs various pieces of information according to an instruction operation of the user. Further, the input unit 217 includes a microphone and an A/D conversion circuit, and others, and outputs data of a voice input via the microphone to the CPU 11 or the storage unit 219.

The output unit 218 includes a display, a speaker, a D/A conversion circuit, and others, and outputs an image and a voice.

The storage unit 219 includes a hard disk, a DRAM, or the like, and stores data of a variety of images and an image database storing attributes, and the like.

The communication unit 220 controls communications with other apparatuses via a network including the Internet.

The drive 221 is mounted with a removable medium 231 configured using a magnetic disk, an optical disk, a magneto-optical disk, a semiconductor memory, or the like, as appropriate. A program read from the removable medium 231 by the drive 221 is installed on the storage unit 219, as necessary. Further, the removable medium 231 can also store a variety of data such as image data stored on the storage unit 219 in the same manner as the storage unit 219.

### [Functional Configuration of the Image Generating Apparatus]

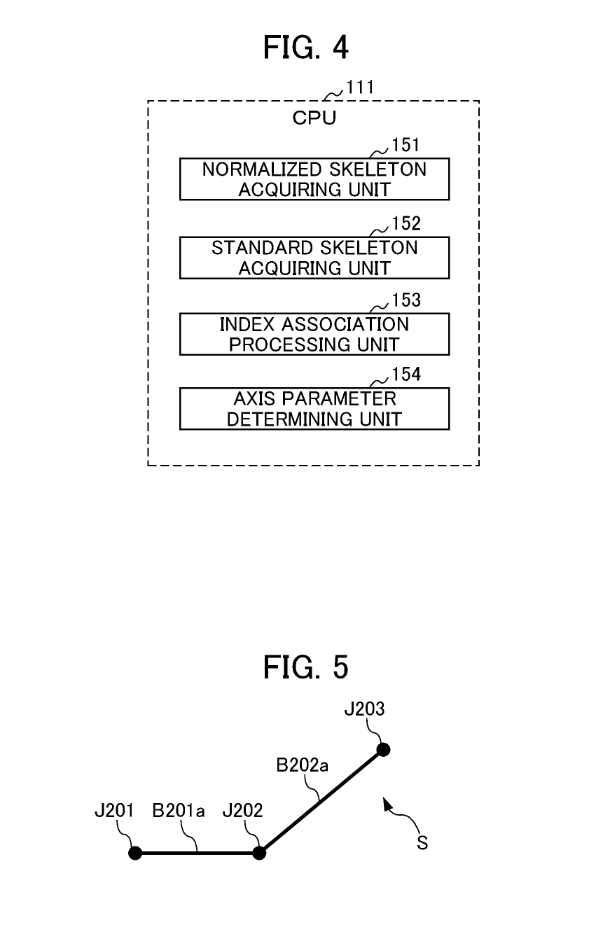

FIG. 4 is a function block diagram illustrating a functional configuration for executing preparation processing among the functional configurations of the image generating apparatus 100.

The preparation processing is a series of processing for acquiring a skeleton as a standard (hereinafter, referred to as a “standard skeleton”) from motion capture data obtained by motion capturing to set an axis parameter regarding a motion for the standard skeleton.

Hereinafter, a case in which animation data of a running person is used as a subject will be described as an example below.

When preparation processing is executed, in the CPU 111, a normalized skeleton acquiring unit 151, a standard skeleton acquiring unit 152, an index association processing unit 153, and an axis parameter determining unit 154 function as an animation acquiring unit 150.

The functions of the normalized skeleton acquiring unit 151, the standard skeleton acquiring unit 152, the index association processing unit 153, and the axis parameter determining unit 154 may be partially transferred to a functional unit such as a GA (Graphic Accelerator) for executing image processing.

The normalized skeleton acquiring unit 151 executes normalized skeleton acquisition processing to be descried later. Specifically, the normalized skeleton acquiring unit 151 acquires data (motion capture data) of a motion of a person obtained by motion capturing and data of a force (here, a ground reaction force) detected by a force plate apparatus (a force measuring apparatus), with respect to a plurality of skeleton motions. In the present embodiment, regarding the motion capture data and the ground reaction force data, those previously measured are acquired by the normalized skeleton acquiring unit 151. However, it is also possible that the image generating apparatus 100 includes a motion capture function and a force plate apparatus and measures motion capture data and ground reaction force data. Further, the normalized skeleton acquiring unit 151 generates data of a skeleton motion from the motion capture data and then normalizes the generated data of the skeleton motion in one cycle of a running form. Thereby, a plurality of skeleton motions normalized (normalized skeleton motions) are acquired.

FIG. 5 is a schematic view illustrating an outline of a skeleton.

In general, the skeleton indicates the whole bone structure of an animal or a human being and expresses motions by itself, and is used to move a model integrated by computer graphics. The skeleton has a hierarchical structure and includes joints that are movable portions and bones that are rigid bodies.

In FIG. 5, a skeleton S has a configuration, in which a root joint J201 that is the highest in the hierarchical structure, a bone B201a, a joint J202, a bone B202a, and a joint J203 are joined in this sequential order.

When the skeleton S includes a posture change on a temporal axis, a skeleton motion that is a temporally changing skeleton is configured. The skeleton motion includes a plurality of frames. Temporal variables of the skeleton motion are 12-dimensional information in total including XYZ coordinate positions as the root of the root joint J201, coordinate conversion information (expressed as angle information including rotation elements of three axes, and expressed as four-dimensional quaternions in the present embodiment) from world coordinates as the joint of the root joint J201 to local coordinates of the root joint J201, and coordinate conversion information of the joint J202 (coordinate conversion information from the root joint J201 to the joint J202).

Use of quaternions makes it possible to perform a calculation for position coordinates at high speed and the like.

Further, a length of the bone is a constant with no temporal change due to a rigid body. The aforementioned coordinate conversion information means a rotational direction where a bone extends from a joint. Hereinafter, in the case of all joints, both a root joint and joints are included.

Return to FIG. 4, and the standard skeleton acquiring unit 152 executes standard skeleton acquisition processing to be described later. Specifically, the standard skeleton acquisition unit 152 extracts temporal axis parameters (position, rotation, and the like) of joints in respective normalized skeletons and calculates average values with respect to the respective joints. Then, the standard skeleton acquiring unit 152 sets the calculated average values as temporal axis parameters for corresponding joints of the standard skeleton. Regarding bones, averaging and then setting are performed. Thereby, a skeleton motion as a standard is set.

The index association processing unit 153 executes index association processing to be described later. Specifically, the index association processing unit 153 acquires an index value regarding a specific motion from motion capture data in a skeleton motion. In this case, the index association processing unit 153 acquires an average value of inclinations of a body axis (an average value of inclinations of the body axis toward a moving direction from a vertical direction). Further, the index association processing unit 153 acquires index values (here, index values indicating a maximum kick force) regarding motions from measurement results (ground reaction forces) of the force plate apparatus in skeleton motions. Then, the index association processing unit 153 associates these acquired index values with all the skeleton motions.

The axis parameter determining unit 154 selects skeleton motions (hereinafter, referred to as “upper skeleton motions” and “lower skeleton motions”) having respective index values regarding motions at a certain upper and a certain lower ratio (here, 20%) in all the normalized skeleton motions, and calculates an index average value of the selected upper skeleton motions and an index average value of the selected lower skeleton motions. Then, the axis parameter determining unit 154 excludes, from the normalized skeleton motions, those where a Euclidean distance between these average values and the normalized skeleton motion is larger than a predetermined value (threshold) D. Further, the axis parameter determining unit 154 selects upper skeleton motions and lower skeleton motions again from the normalized skeleton motions after exclusion, and calculates an average value of the index values of the upper skeleton motions and an average value of the index values of the lower skeleton motions to exclude normalized skeleton motions based on the threshold D. The axis parameter determining unit 154 executes processing for such exclusion a plurality of times (e.g., three times). This makes it possible to select skeleton motions having upper and lower index values with high accuracy in data of skeleton motions of a larger number of dimensions.

The axis parameter determining unit 154 executes axis parameter determination processing to be described later. Specifically, the axis parameter determining unit 154 stores the average value of the index values of the upper skeleton motions and the average value of the index values of the lower skeleton motions obtained as described above on the storage unit 118 as standard values of axis parameters corresponding to the respective index values, with respect to the upper skeleton motions and the lower skeleton motions of the respective index values.

### [Functional Configuration of the Terminal Apparatus]

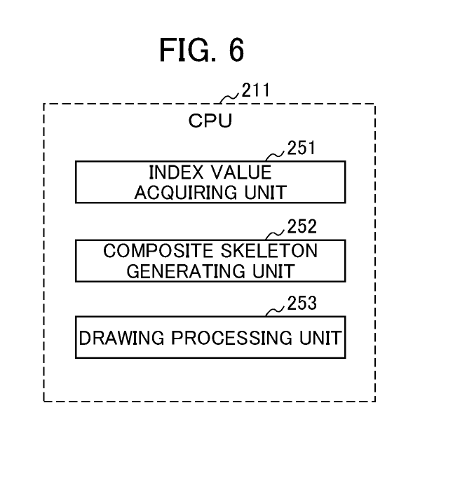

FIG. 6 is a function block diagram illustrating a functional configuration for executing skeleton drawing processing among the functional configurations of the terminal apparatus 200.

The skeleton drawing processing is a series of processing for generating a composite skeleton motion where a degree of motion is changed according to an input index value to draw the generated composite skeleton motion.

When skeleton drawing processing is executed, in the CPU 211, an index value acquiring unit 251, a composite skeleton generating unit 252, and a drawing processing unit 253 function.

The functions of the index value acquiring unit 251, the composite skeleton generating unit 252, and the drawing processing unit 253 may be partially transferred to a functional unit such as a GA (Graphic Accelerator) for executing image processing.

The index value acquiring unit 251 acquires an index value input by the user in a user interface screen.

In the user interface screen, when, for example, upon an index value of “25” regarding a kick force of the standard skeleton motion, the user newly inputs “40” as a value of the maximum kick acceleration, the index value acquiring unit 251 acquires “40” as the value of the maximum kick acceleration.

The composite skeleton generating unit 252 executes composite skeleton generation processing to be described later. Specifically, the composite skeleton generating unit 252 changes an index value of the standard skeleton based on the index value acquired by the index value acquiring unit 251 and generates a composite skeleton motion. When, for example, the index value acquiring unit 251 has acquired a value of “40” of the maximum acceleration after changed, the composite skeleton generating unit 252 generates a composite skeleton motion where the maximum kick acceleration in the standard skeleton has been changed from “25” to “40.”

The drawing processing unit 253 displays, as a moving image, the composite skeleton motion generated by the composite skeleton generating unit 252. At that time, the drawing processing unit 253 displays an index where a change has been made from the standard skeleton motion in the composite skeleton motion by visually discriminating the index. When, for example, a value of the maximum kick acceleration in the composite skeleton motion has been changed with respect to the standard skeleton motion, the drawing processing unit 253 displays an arrow for a portion (e.g., a leg) involved in the value of the maximum kick acceleration to be displayed by discriminating the change from the standard skeleton motion.

### [Operations]

Next, operations will be described below.

### [Preparation Processing]

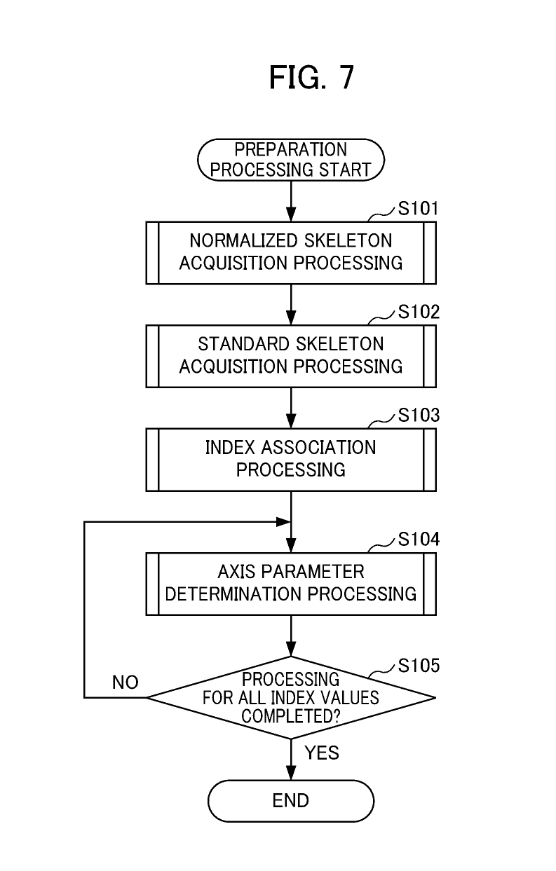

FIG. 7 is a flowchart illustrating one example of a flow of preparation processing executed by the image generating apparatus 100 of FIG. 2 having the functional configuration of FIG. 4.

The preparation processing is started in response to an input of the start of preparation processing via the terminal apparatus 200 or the like.

When preparation processing starts, in Step S101, the normalized skeleton acquiring unit 151 executes normalized skeleton acquisition processing (described later).

In Step S102, the standard skeleton acquiring unit 152 executes standard skeleton acquisition processing (described later).

In Step S103, the index association processing unit 153 executes index association processing (described later).

In Step S104, the axis parameter determining unit 154 executes axis parameter determination processing (described later).

In Step S105, the axis parameter determining unit 154 determines whether determination processing of axis parameters has been completed for all the indexes.

When axis parameter determination processing has not been completed for all the indexes, a determination is made as NO in Step S105 and then the processing returns to Step S104.

In contrast, when axis parameter determination processing has been completed for all the indexes, a determination is made as YES in Step S105 and then the preparation processing ends.

### [Normalized Skeleton Acquisition Processing]

Next, normalized skeleton acquisition processing executed in Step S101 of preparation processing will be described below.

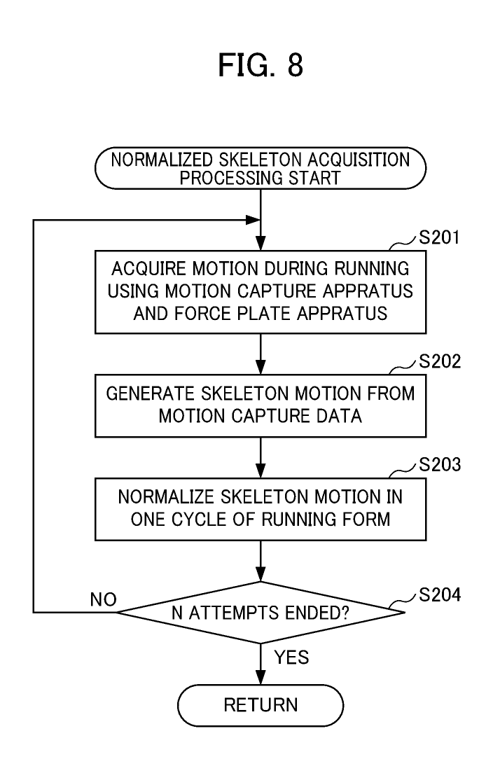

FIG. 8 is a flowchart illustrating one example of a flow of normalized skeleton acquisition processing in the preparation processing.

When normalized skeleton acquisition processing starts, in Step S201, the normalized skeleton acquiring unit 151 acquires, as data of a motion during running, motion capture data and data of a ground reaction force measured using an optical motion capture apparatus and a force plate apparatus.

Specifically, the normalized skeleton acquiring unit 151 acquires a form of a running motion expressed by a motion of a marker placed on a subject to be measured of a motion from the optical motion capture apparatus. The optical motion capture apparatus is an apparatus for tracing a marker placed on a site where a motion in a person is intended to be measured, using a large number of cameras.

The marker is placed on a position where in a person serving as a subject to be measured of a motion, a joint site for constructing a skeleton can be extrapolated. In other words, motion capture makes it possible to trace a joint position of a skeleton.

Further, the normalized skeleton acquiring unit 151 acquires the data of a ground reaction force during running from the force plate apparatus.

As one example, the force plate apparatus is buried in the ground, and acquires information on a ground reaction force when a person serving as a subject to be measured runs thereon. The ground reaction force makes it possible to obtain a kick force toward a direction vertical to the ground from the subject to be measured and a driving force to a moving direction.

The ground reaction force is a force and therefore, is derivable from the following expression (1) in accordance with Newton's law of motion.

F=M×a (1)

wherein, “F,” “m,” and “a” represent force, mass, and acceleration, respectively. Since depending on mass, “F” depends on a weight of a person serving as a subject to be measured. Therefore, the ground reaction force is treated not as a force but as an acceleration to realize an index that is independent of the weight of the person serving as a subject to be measured.

In the present embodiment, a value of the maximum kick acceleration (i.e., the maximum value of the kick acceleration values) is used as an index value of a motion and therefore, an index value indicating the value of the maximum kick acceleration is stored by being associated with motion capture data and then used in processing that follows.

In Step S202, the normalized skeleton acquiring unit 151 acquires a skeleton motion. Specifically, the normalized skeleton acquiring unit 151 generates a skeleton motion from the motion capture data acquired from the motion capture apparatus. The normalized skeleton acquiring unit 151 estimates joint positions of a skeleton from the motion capture data and then determines a portion between the joints as a bone. However, upon determination of a bone in this manner, since the bone is not strictly a rigid body but may expand and contract, the normalized skeleton acquiring unit 151 generates a skeleton motion by total optimization so that the estimated joint positions are satisfied as much as possible while the bone is restricted to be a rigid body.

In Step S203, the normalized skeleton acquiring unit 151 normalizes the skeleton motion.

Specifically, the normalized skeleton acquiring unit 151 normalizes the skeleton motion in accordance with the periodicity of a running form. In the present embodiment, a normalization is performed in such a manner that at a timing when the knee of the right leg passes the knee of the left leg, moving images of a skeleton motion are cut out, and then in order to match the number cut frames, an interpolation is performed so as to realize the same number of frames (e.g., 100 frames) for all the moving images. When the interpolation is performed, a data interpolation is performed with respect to position information on a root joint and angle information possessed by the root joint and joints.

The normalized skeleton acquiring unit 151 performs a skeleton motion normalization for a plurality of skeleton motions (skeleton motions of N attempts) and then generates N normalized skeleton motions. Further, each normalized skeleton motion is associated with an index value indicating a value of the maximum kick acceleration as one of the index values.

In Step S204, the normalized skeleton acquiring unit 151 determines whether the skeleton motion normalization has been performed for N attempts.

When the skeleton motion normalization has not been performed for N attempts, in Step S204, a determination is made as NO and the processing returns to Step S201.

In contrast, when the skeleton motion normalization has been performed for N attempts, in Step S204, a determination is made as YES and the processing returns to preparation processing.

### [Standard Skeleton Acquisition Processing]

Next, standard skeleton acquisition processing executed in Step S102 of preparation processing will be described below.

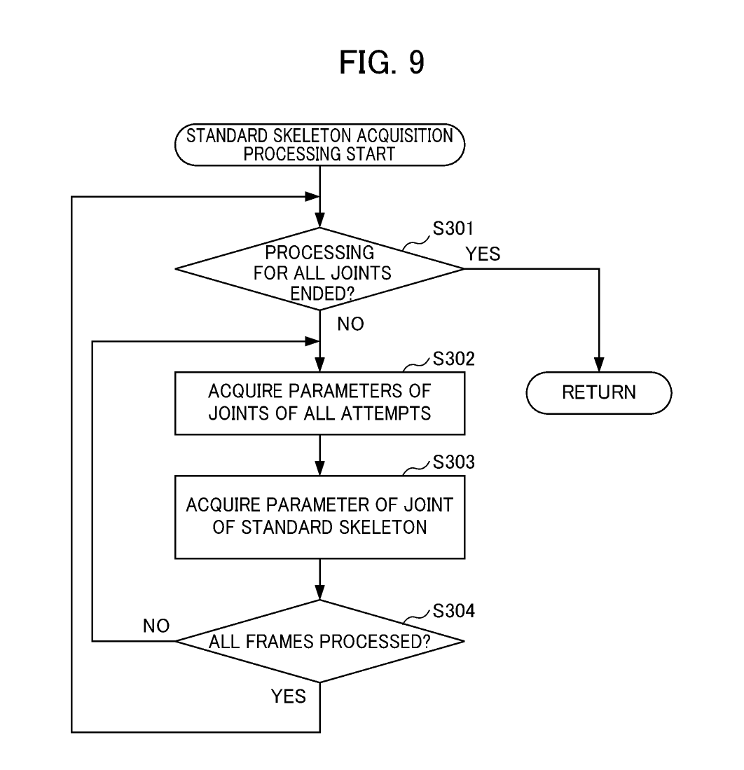

FIG. 9 is a flowchart illustrating one example of a flow of standard skeleton acquisition processing in the preparation processing.

When standard skeleton acquisition processing starts, in Step S301, the standard skeleton acquiring unit 152 determines whether processing for all the joints has ended. In other words, the standard skeleton acquiring unit 152 determines whether processing for all the frames with respect to all the respective joints (the root joint and the respective joints) has been executed.

When processing for all the frames with respect to the respective joints has been executed, in Step S301, a determination is made as YES and then the processing returns to preparation processing.

In contrast, when processing for all the frames with respect to the respective joints has not been executed, in Step S301, a determination is made as NO and then the processing moves to Step S302.

In Step S302, the standard skeleton acquiring unit 152 acquires a parameter of a joint of all the attempts.

In Step S303, the standard skeleton acquiring unit 152 calculates a parameter of a joint of a standard skeleton. The parameter of a joint of the standard skeleton is determined as an average value of variables in each joint extracted in all the attempts. The average value here is calculated independently for each of the components of the X axis, the Y axis, and the Z axis.

For example, in the case of the root joint, an average value of position coordinates of a corresponding frame in all the attempts is determined as position coordinates of the frame of the standard skeleton motion.

Further, angle information represented by quaternions is calculated in accordance with the following expression (2). In other words, an average value of five quaternions of q1, q2, q3, q4, and q5 is calculated by the following expression.

Qmean=exp((⅕)×(ln(q1)+ln(q2)ln(q3)+ln(q4)+ln(q5)) (2)

wherein, “exp” represents an exponential function having a Napier's constant as the base and “ln” represents the natural logarithm.

In this manner, when a conversion is performed to logarithmic quaternions, an average value for the standard skeleton motion can be acquired.

In Step S304, the standard skeleton acquiring unit 152 determines whether processing for all the frames has been executed.

When processing for all the frames has been executed, in Step S304, a determination is made as YES and then the processing returns to preparation processing.

In contrast, when processing for all the frames has not been executed, in Step S304, a determination is made as NO and then the processing returns to Step S302.

### [Index Association Processing]

Next, index association processing executed in Step S103 of preparation processing will be described below.

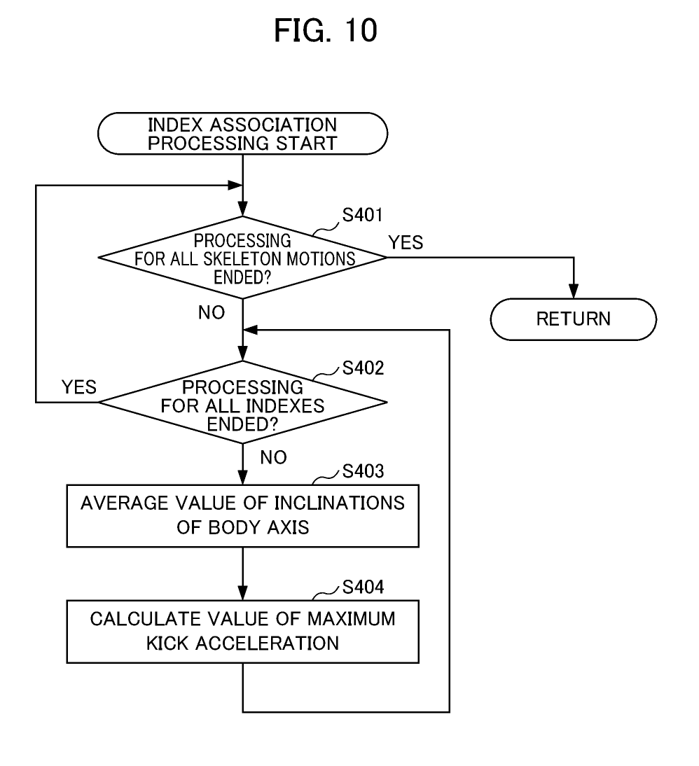

FIG. 10 is a flowchart illustrating one example of a flow of index association processing in the preparation processing.

When index association processing starts, in Step S401, the index association processing unit 153 determines whether processing for all the skeleton motions (i.e., processing for generating a standard skeleton motion for all the normalized skeleton motions) has ended.

When processing for all the skeleton motions has ended, in Step S401, a determination is made as YES and then the processing returns to preparation processing.

In contrast, when processing for all the skeleton motions has not ended, in Step S401, a determination is made as NO and then the processing advances to Step S402.

In Step S402, the index association processing unit 153 determines whether processing for all the index values regarding a motion has ended.

When processing for all the index values regarding the motion has ended, in Step S402, a determination is made as YES and then the processing returns to Step S401.

In contrast, when processing for all the index values regarding the motion has not ended, in Step S402, a determination is made as NO and then the processing advances to Step S403.

In Step S403, the index association processing unit 153 calculates an average value of inclinations of a body axis. The average value of inclinations of the body axis is calculated by determining an average value of inclinations of front and back directions of the body axis. The “body axis” means a vector toward the center of the right and left shoulder joints from the center of the right and left hip joints. In the present embodiment, an average value of body axis vectors in all the frames of one normalized skeleton motion is calculated and an inclination toward a running movement direction from the vertical direction is designated as an average value of inclinations of the body axis. This is also applied to the standard skeleton motion in the same manner, and an average value of body axis vectors in all the frames is calculated to calculate an average value of inclinations of the body axis. Then, the calculated average value of inclinations of the body axis is associated with respective skeleton motions.

In Step S404, the index association processing unit 153 calculates a value of the maximum kick acceleration.

The value of the maximum kick acceleration is acquired as a maximum value in components of the vertical direction of the ground reaction forces acquired by the force plate apparatus. Then, in a motion of one cycle, an index value indicating the value of the maximum kick acceleration is associated with a normalized skeleton motion of a frame corresponding to the maximum value. Regarding the standard skeleton motion, the average value of maximum kick acceleration values in the normalized skeleton motions used upon generating a standard skeleton motion is designated as an index value indicating the value of the maximum kick acceleration of the standard skeleton motion.

After Step S404, the processing returns to Step S402.

### [Axis Parameter Determination Processing]

Next, axis parameter determination processing executed in Step S104 of preparation processing will be described below.

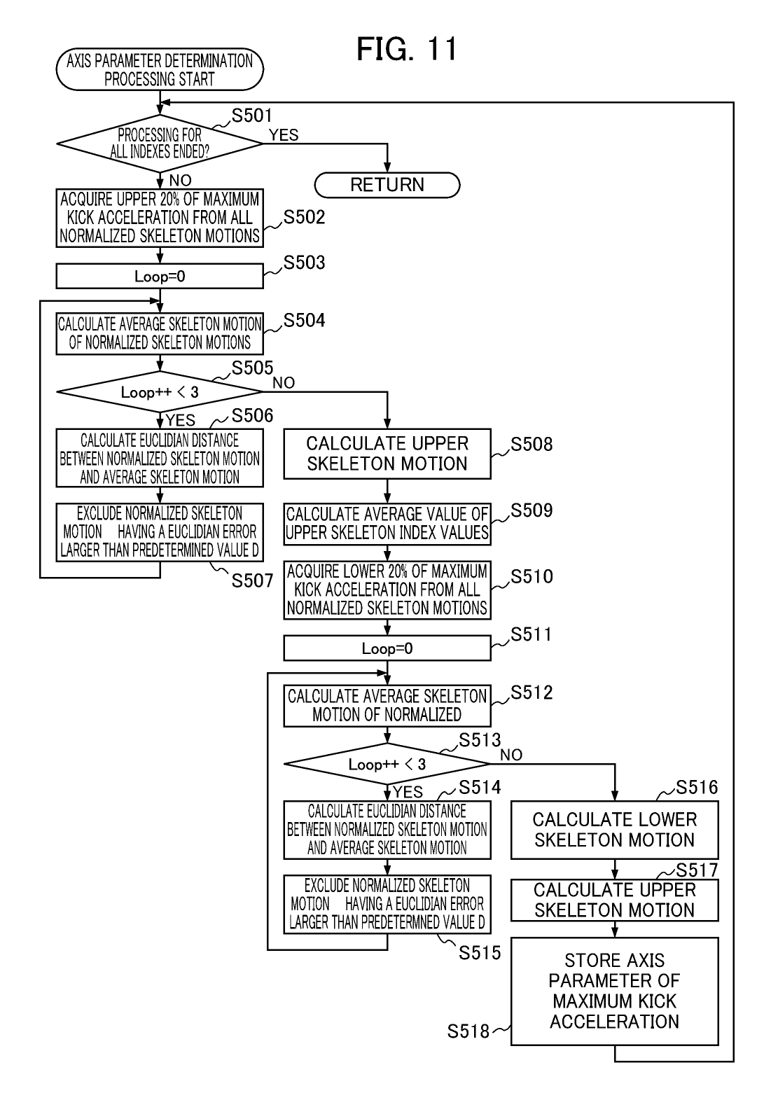

FIG. 11 is a flowchart illustrating one example of a flow of axis parameter determination processing in the preparation processing.

When axis parameter determination processing starts, in Step S501, the axis parameter determining unit 154 determines whether processing for all the index values regarding a motion has ended.

When processing for all the index values regarding the motion has ended, in Step S501, a determination is made as YES and then the processing returns to preparation processing.

When processing for all the index values regarding the motion has not ended, in Step S501, a determination is made as NO and then the processing advances to Step S502.

In Step S502, the axis parameter determining unit 154 acquires normalized skeleton motions having a value of the maximum kick acceleration falling within the upper 20% from all the normalized skeleton motions. However, those having a value smaller than the value of the maximum kick acceleration of the standard skeleton motion are excluded when included.

In Step S503, the axis parameter determining unit 154 sets a variable Loop to be zero (Loop=0).

In Step S504, the axis parameter determining unit 154 calculates an average skeleton motion (i.e., an average value of upper skeleton motions) of the acquired normalized skeleton motions.

In Step S505, the axis parameter determining unit 154 determines whether the variable Loop stepped in increments of one is less than three (Loop++<3).

When the variable Loop is not less than three, in Step S505, a determination is made as NO and then the processing advances to Step S508.

In contrast, when the variable Loop is less than three, in Step S505, a determination is made as YES and then the processing advances to Step S506.

In Step S506, the axis parameter determining unit 154 calculates a Euclidean distance between a selected skeleton motion and the average skeleton motion. In other words, in the same manner as in generation of the standard skeleton motion, the axis parameter determining unit 154 calculates an average value of upper skeleton motions and generates an upper average skeleton motion. Then, the axis parameter determining unit 154 develops the generated upper average skeleton motion in a position space. In other words, the axis parameter determining unit 154 converts variables and constants (position and angle information of a root joint, bone length, and angle information in respective joints) possessed by all the frames into a root joint position and joint positions serving as space position coordinates. Then, the axis parameter determining unit 154 determines space position errors (Euclidean errors) integrated in all the frames between the generated upper average skeleton motion and the respective normalized skeleton motions used for generating the upper average skeleton motion. The thus-determined Euclidian errors represent Euclidian distances.

In Step S507, the axis parameter determining unit 154 excludes, from a selection, normalized skeleton motions having a Euclidian error (Euclidian distance) larger than a predetermined value D. In other words, skeleton motions distant in position coordinates are excluded from the upper average skeleton motion. Thereafter, the processing returns to Step S504 and then generates an upper average skeleton motion again.

In Step S508, the axis parameter determining unit 154 calculates upper skeleton motions. In other words, the axis parameter determining unit 154 designates the generated upper average skeleton motion as a representative of skeleton motions having a large value of the maximum kick acceleration and as an upper skeleton motion regarding the value of the maximum kick acceleration. Further, the axis parameter determining unit 154 determines a value of the maximum kick acceleration corresponding to the upper skeleton motion. The value of the maximum kick acceleration is an average value of the values of the maximum kick acceleration of the normalized skeleton motions used for generating the upper skeleton motion.

In Step S509, the axis parameter determining unit 154 calculates an average value (an upper standard value) of index values of upper skeleton motions. In other words, the axis parameter determining unit 154 calculates an average value of values of the maximum kick acceleration from the selected upper skeleton motions and designates the average value as an upper standard value.

In Step S510, the axis parameter determining unit 154 acquires normalized skeleton motions having a small value of the maximum kick acceleration value falling within the lower 20% from all the normalized skeleton motions. However, those having a value larger than the value of the maximum kick acceleration of the standard skeleton motion are excluded when included.

In Step S511, the axis parameter determining unit 154 sets the variable Loop to be zero (Loop=0).

In Step S512, the axis parameter determining unit 154 calculates an average skeleton motion (i.e., an average value of lower skeleton motions) of the acquired normalized skeleton motions.

In Step S513, the axis parameter determining unit 154 determines whether the variable Loop stepped in increments of one is less than three (Loop++<3).

When the variable Loop is not less than three, in Step S513, a determination is made as NO and then the processing advances to Step S516.

In contrast, when the variable Loop is less than three, in Step S513, a determination is made as YES and then the processing advances to Step S514.

In Step S514, the axis parameter determining unit 154 calculates a Euclidean distance between a selected skeleton motion and the average skeleton motion. In other words, in the same manner as in generation of the standard skeleton motion, the axis parameter determining unit 154 calculates an average value of lower skeleton motions and generates a lower average skeleton motion. Then, the axis parameter determining unit 154 develops the generated lower average skeleton motion in the position space. In other words, the axis parameter determining unit 154 converts variables and constants (position and angle information of a root joint, bone length, and angle information in respective joints) possessed by all the frames into a root joint position and joint positions serving as space position coordinates. Then, the axis parameter determining unit 154 determines space position errors (Euclidean errors) integrated in all the frames between the generated lower average skeleton motion and the respective normalized skeleton motions used for generating the lower average skeleton motion. The thus-determined Euclidian errors represent Euclidian distances.

In Step S515, the axis parameter determining unit 154 excludes, from a selection, normalized skeleton motions having a Euclidian error (Euclidian distance) larger than the predetermined value D. In other words, skeleton motions distant in position coordinates are excluded from the lower average skeleton motion. Thereafter, the processing returns to Step S512 and then generates a lower average skeleton motion again.

In Step S516, the axis parameter determining unit 154 calculates lower skeleton motions. In other words, the axis parameter determining unit 154 designates the generated lower average skeleton motion as a representative of skeleton motions having a small value of the maximum kick acceleration and as a lower skeleton motion regarding the value of the maximum kick acceleration. Further, the axis parameter determining unit 154 determines a lower value of the maximum kick acceleration corresponding to the lower skeleton motion. The lower value of the maximum kick acceleration is designated as an average value of the values of the maximum kick acceleration of the normalized skeleton motions used for generating the lower skeleton motion.

In Step S517, the axis parameter determining unit 154 calculates an average value (a lower standard value) of index values of lower skeleton motions. In other words, the axis parameter determining unit 154 calculates an average value of values of the maximum kick acceleration from the selected lower skeleton motions and designates the average value as a lower standard value.

In Step S518, the axis parameter determining unit 154 stores the index value indicating the value of the maximum kick acceleration of the standard skeleton motion, the upper skeleton motion of the value of the maximum kick acceleration, the upper standard value of the maximum kick acceleration, the lower skeleton motion of the value of the maximum kick acceleration, and the lower standard value of the maximum kick acceleration on the storage unit 118 as axis parameters of the value of the maximum kick acceleration.

After Step S518, the processing returns to Step S501.

In Step S507 and Step S515, evaluation in the position space has been conducted but evaluation may be conducted using a deviation of rotation amounts themselves of all the joints.

### [Skeleton Drawing Processing]

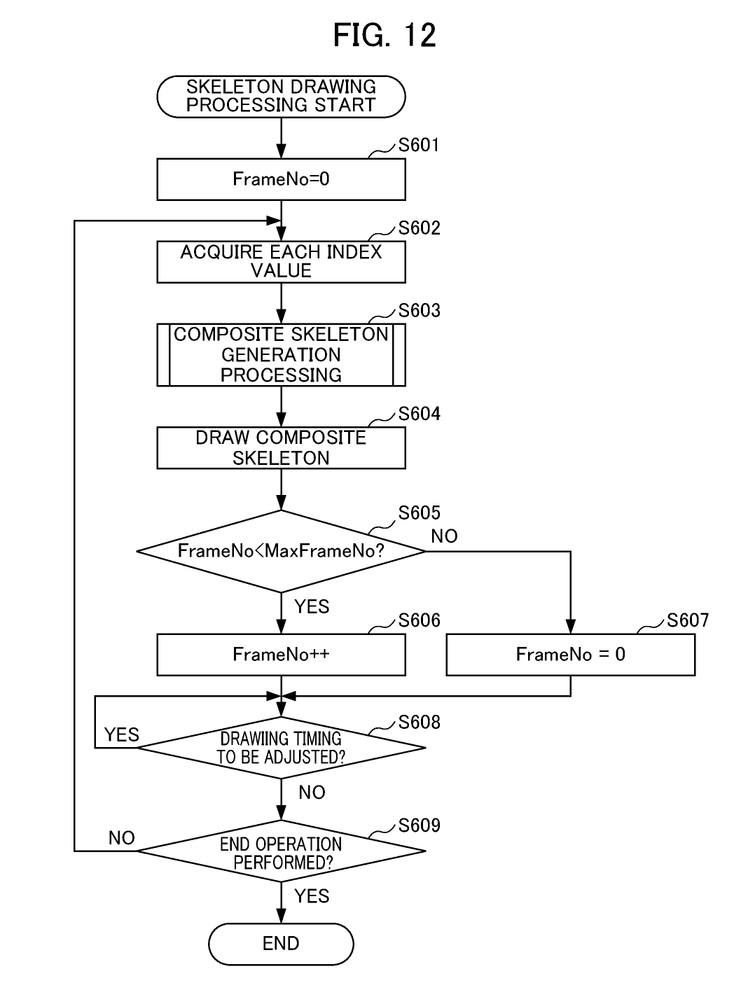

FIG. 12 is a flowchart illustrating one example of a flow of skeleton drawing processing executed by the terminal apparatus 200 of FIG. 3 having the functional configuration of FIG. 6.

The skeleton drawing processing is started in response to an input of the start of skeleton drawing processing via the input unit 217.

When skeleton drawing processing starts, in Step S601, the drawing processing unit 253 initiates a frame variable (FrameNo=0).

In Step S602, the index value acquiring unit 251 acquires an index value input regarding each motion. When, for example, a motion index is provided using a slide bar in the user interface, the index value acquiring unit 251 acquires an index value indicated by the slide bar.

In Step S603, the composite skeleton generating unit 252 executes composite skeleton generation processing (described later). On the basis of the acquired index value regarding a motion, composite skeleton generation processing generates a composite skeleton of a frame number (FrameNo) thereof.

In Step S604, the drawing processing unit 253 controls the output unit 218 to draw the composite skeleton. In composite skeleton drawing, position coordinates of a moving direction of the root joint are fixed so that the composite skeleton does not move in the moving direction.

In Step S605, the drawing processing unit 253 determines whether a frame to be drawn has a smaller number than the maximum frame number (FrameNo<MaxFrameNo).

When the number of the frame to be drawn is not smaller than the maximum frame number, in Step S605, a determination is made as NO and then the processing advances to Step S607.

In Step S607, the drawing processing unit 253 resets the frame number (FrameNo=0).

Thereafter, the processing advances to Step S608.

In contrast, when the number of the frame to be drawn is smaller than the maximum frame number, in Step S605, a determination is made as YES and then the processing advances to Step S606.

In Step S606, the drawing processing unit 253 increments the frame number by one (FrameNo++).

In Step S608, the drawing processing unit 253 determines whether to perform a drawing timing adjustment. In other words, a change in an index value regarding a motion causes a need for frame interpolation, removal, or the like and then a determination whether to adjust a drawing timing of a frame is made.

When the drawing timing is adjusted, the processing of Step S608 is repeated.

In contrast, when no drawing timing is adjusted, in Step S608, a determination is made as NO and then the processing advances to Step S609.

In Step S609, the drawing processing unit 253 determines whether an end operation of skeleton drawing processing has been performed.

When no end operation has been performed, in Step S609, a determination is made as NO and then the processing returns to Step S602.

In contrast, when an end operation has been performed, in Step S609, a determination is made as YES and then the skeleton drawing processing ends.

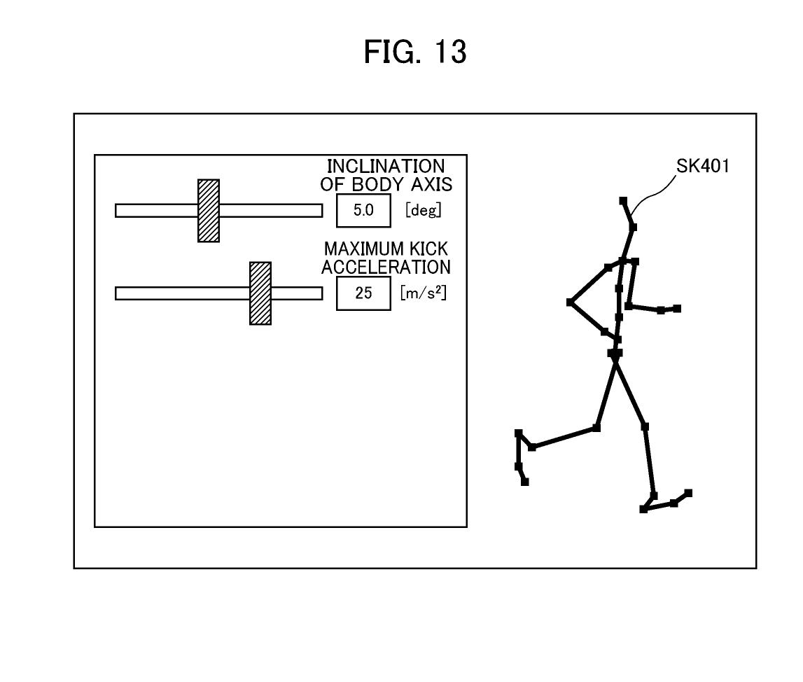

FIG. 13 is a schematic view illustrating a display screen example displayed by skeleton drawing processing.

As illustrated in FIG. 13, on the left side of the display screen, there are displayed slide bars indicating an average value of inclinations of the body axis and a value of the maximum kick acceleration as index values regarding a motion, and current set values (an average value of inclinations of the body axis: 5.0 (deg.) and a value of the maximum kick acceleration: 25 (m/s²)). Further, on the right side of the display screen, a composite skeleton SK401 is displayed.

In the display screen example illustrated in FIG. 13, the slide bars can change the respective index values regarding a motion, i.e., the average value of inclinations of the body axis and the value of the maximum kick acceleration.

### [Composite Skeleton Generation Processing]

Next, composite skeleton generation processing executed in Step S603 of skeleton drawing processing will be described.

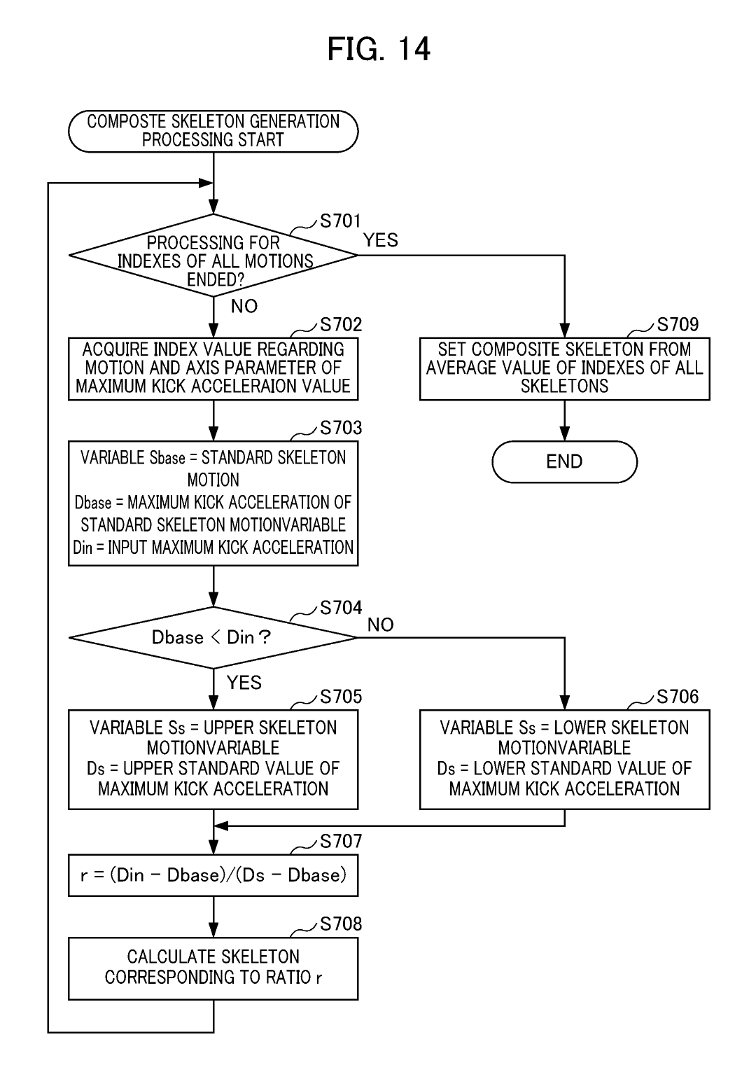

FIG. 14 is a flowchart illustrating one example of a flow of composite skeleton generation processing in the skeleton drawing processing.

In the present embodiment, a case in which an index value indicating the value of the maximum kick acceleration is changed will be described as an example below.

When composite skeleton generation processing starts, in Step S701, the composite skeleton generating unit 252 determines whether processing for index values regarding all the motions has ended.

When processing for the index values regarding all the motions has ended, in Step S701, a determination is made as YES and then the processing advances to Step S709.

In contrast, when processing for the index values regarding all the motions has not ended, in Step S701, a determination is made as NO and then the processing advances to Step S702.

In Step S702, the composite skeleton generating unit 252 acquires index values input regarding the respective motions and axis parameters of the value of the maximum kick acceleration (the index value of the value of the maximum kick acceleration of the standard skeleton motion, the upper skeleton motion of the value of the maximum kick skeleton motion, the upper standard value of the value of the maximum kick acceleration, the lower skeleton motion of the value of the maximum kick acceleration, and the lower standard value of the value of the maximum kick acceleration acquired in Step S518, which is the step in the axis parameter determination processing).

In Step S703, the composite skeleton generating unit 252 sets a standard skeleton motion (time=frame number FrameNo) for a variable Sbase, sets an index value (a value of the maximum kick acceleration) regarding a motion of the standard skeleton motion for a variable Dbase, and sets the input value of the maximum kick acceleration for a variable Din.

An example for setting is as follows: Sbase=a standard skeleton motion (a frame of frame number FrameNo), Dbase=a value of “25” of the maximum skeleton acceleration of the standard skeleton motion, and Din=an input value of “40” of the maximum kick acceleration.

In Step S704, the composite skeleton generating unit 252 determines whether the input value of the maximum kick acceleration is larger than the index value regarding a motion of the standard skeleton motion (Dbase<Din).

When the input value of the maximum kick acceleration is larger than the index value regarding a motion of the standard skeleton motion, in Step S704, a determination is made as YES and then the processing advances to Step S705.

In Step S705, the composite skeleton generating unit 252 sets an upper skeleton motion (time=frame number FrameNo) of the axis parameter for a variable Ss and sets an upper standard value of the maximum kick acceleration of the axis parameter for a variable Ds.

An example for setting is as follows: Ss=an upper skeleton motion (a frame of frame number FrameNo) of the axis parameter and Ds=an upper standard value “35” of the axis parameter.

Thereafter, the processing advances to Step S707.

In contrast, when the input value of the maximum kick acceleration is smaller than the index value regarding a motion of the standard skeleton motion, in Step S704, a determination is made as NO and then the processing advances to Step S706.

In Step S706, the composite skeleton generating unit 252 sets a lower skeleton motion (time=frame number FrameNo) of the axis parameter for the variable Ss and sets a lower standard value of the maximum kick acceleration of the axis parameter for the variable Ds.

An example for setting is as follows: Ss=a lower skeleton motion (a frame of frame number FrameNo) of the axis parameter and Ds=a lower standard value “10” of the axis parameter.

In Step S707, the composite skeleton generating unit 252 calculates the following expressing: ratio r=(Din−Dbase)/(Ds−Dbase).

Specifically, when on the basis of Dbase, setting is made as one up to Ds, a ratio where an input index value Din is located is determined as r. In other words, in the case of r=0, the input index value Din=Dbase, in the case of r=1, Din=Ds, in the case of r>1, Din>Ds, and in the case of 0<r<1, Dbase<Din<Ds.

In Step S708, the composite skeleton generating unit 252 determines a skeleton (skeleton after changed) corresponding to the ratio r. Regarding position coordinates of the root joint, X, Y, and Z axes are calculated independently of each other, and, for example, regarding the X coordinate, a calculation is performed in accordance with the following expression (3).

X′=x_base+r×(x_{—}s−x_base) (3)

“X′” represents an X coordinate value of the root joint of a characteristic skeleton. In the same manner, a Y coordinate value and a Z coordinate value are also determined. Further, “x_s” represents an X coordinate value of the root joint in a frame of the upper skeleton motion indicated by Ss and “x_base” represents an X coordinate value of the root joint in a frame of the standard skeleton motion indicated by Sbase.

Further, in the same manner, regarding angle information expressed by quaternions, a value after changed can also be determined using the following interpolation formula.

q′=q_base×(inv(q_base)×q_{—}s)r

The term “q_base” represents quaternions of the standard skeleton, “q_s” represents quaternions of the upper skeleton motion Ss, and “inv( )” represents an inverse function.

The composite skeleton generating unit 252 calculates all pieces of angle information and then determines a skeleton. Regarding bones, bones of the standard skeleton are used.

Thereafter, the processing returns to Step S701.

In Step S709, the composite skeleton generating unit 252 sets a composite skeleton from an average value of index values of all the skeletons.

Thereafter, the processing returns to skeleton drawing processing.

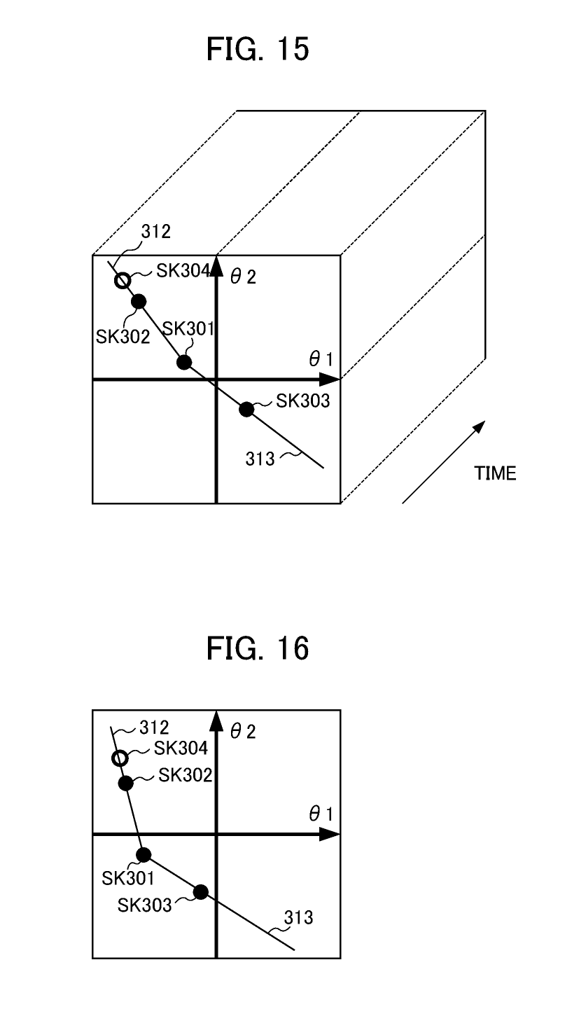

FIG. 15 is a schematic view illustrating a time-series skeleton space.

As illustrated in FIG. 15, variables of the skeleton space include position coordinates of the root joint and dimensions containing angle information of the root joint and joints.

For simple description here, the angle information is assumed to have two dimensions of θ1 and θ2.

It is assumed that in a desired frame, a standard skeleton motion is SK301, an upper skeleton motion is SK302, and a lower skeleton motion is SK303. On an axis 312 from the standard skeleton motion SK301 to the upper skeleton motion SK302, a skeleton motion SK304 after changed is set. The skeleton motion SK304 differs for every time point, i.e., different frames each include different variables of skeleton motions, resulting in different skeleton motions SK304.

FIG. 16 is a schematic view illustrating a skeleton space of a frame (frame number=k) different from that in FIG. 15.

The axis 312 is an interpolation axis upon viewing the upper skeleton motion SK302 from the standard skeleton motion SK301. Further, the axis 313 is an interpolation axis upon viewing the lower skeleton motion SK303 from the standard skeleton motion SK301. In other words, when the ratio r is variously changed with respect to an index regarding a specific motion, the skeleton motion SK304 set on the axis 312 or the axis 313.

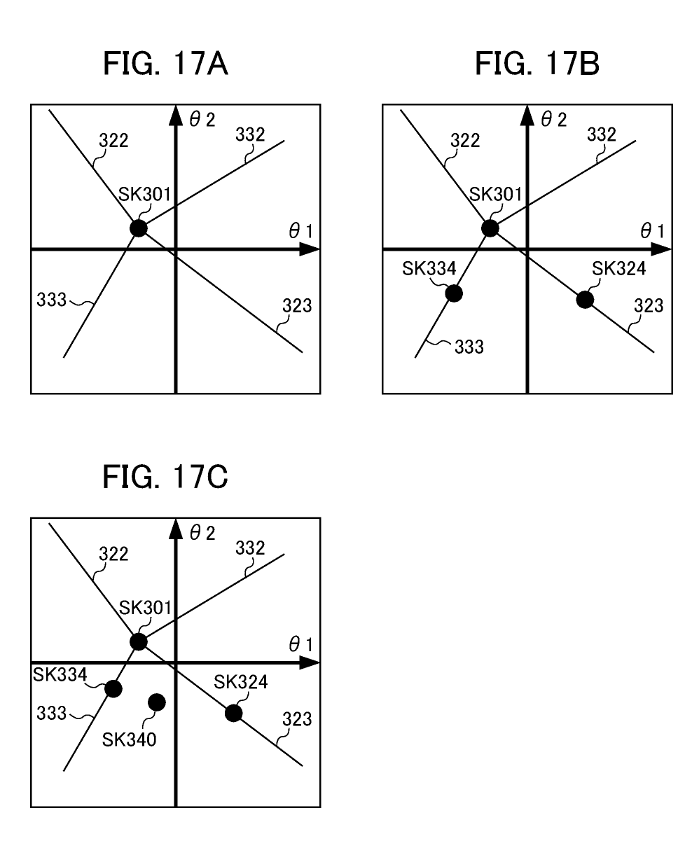

FIG. 17 is a schematic view illustrating a composite skeleton in a skeleton space.

FIG. 17A illustrates a state where the standard skeleton motion SK301 is set in the skeleton space, and FIG. 17B illustrates skeleton motions SK324 and SK334 according to index values regarding different motions. Further, FIG. 17C illustrates a composite skeleton motion SK340.

The axes 322 and 323 and the axes 332 and 333 illustrated in FIG. 17A represent interpolation axes according to respective index values regarding different motions, and when ratios r in the index values regarding these motions are input, the skeleton motions SK324 and SK334 in FIG. 17B are set, respectively.

Then, as illustrated in FIG. 17C, when an average value of coordinates of the skeleton motions SK324 and SK334 is acquired, angle information on the composite skeleton motion SK340 is obtained and then the composite skeleton motion SK340 is set.

In the above description, for an index value regarding one motion, two interpolation directions of an upper skeleton motion and a lower skeleton motion are set to set a linear axis using one skeleton motion for each. However, also when a plurality of skeleton motions are set and an axis is set using a broken line instead of a straight line, a composite skeleton can be set using the same algorithm. Setting of an axis including a larger number of broken points makes it possible to appropriately respond to a more complex motion.

### [Specific Embodiment of Visualization]

Next, a specific embodiment upon drawing a composite skeleton using the drawing processing unit 253 of the terminal apparatus 200 will be described below.

### [First Arrow Drawing Processing]

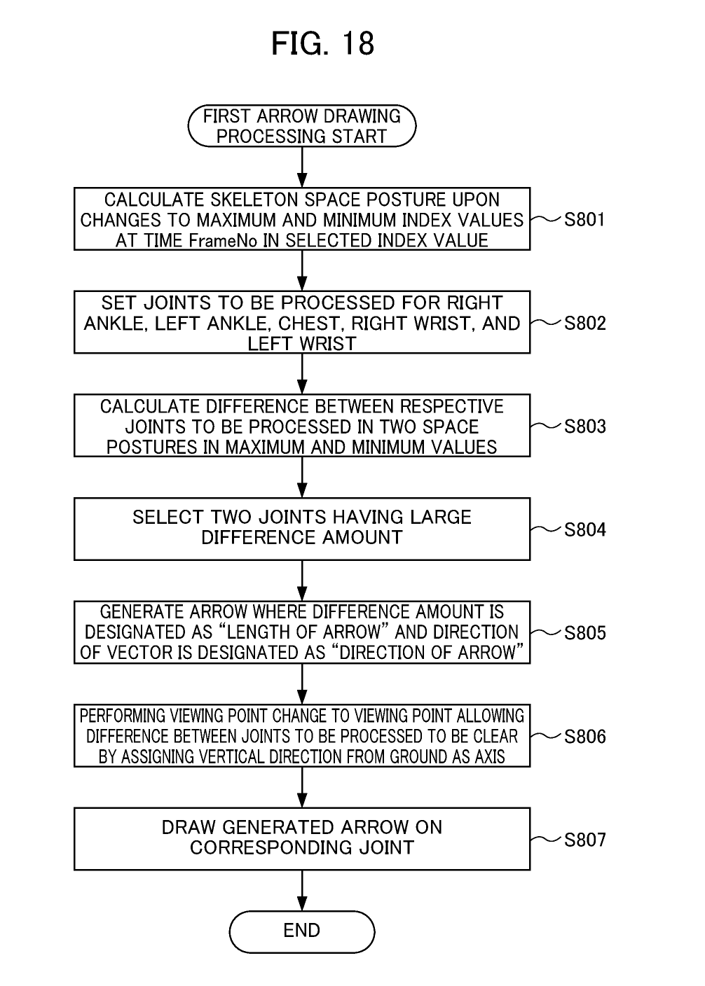

FIG. 18 is a flowchart illustrating a flow of first arrow drawing processing executed by the terminal apparatus 200 of FIG. 3 having the functional configuration of FIG. 5.

The first arrow drawing processing is processing for generating an arrow displaying a changed state of a skeleton for visualization.

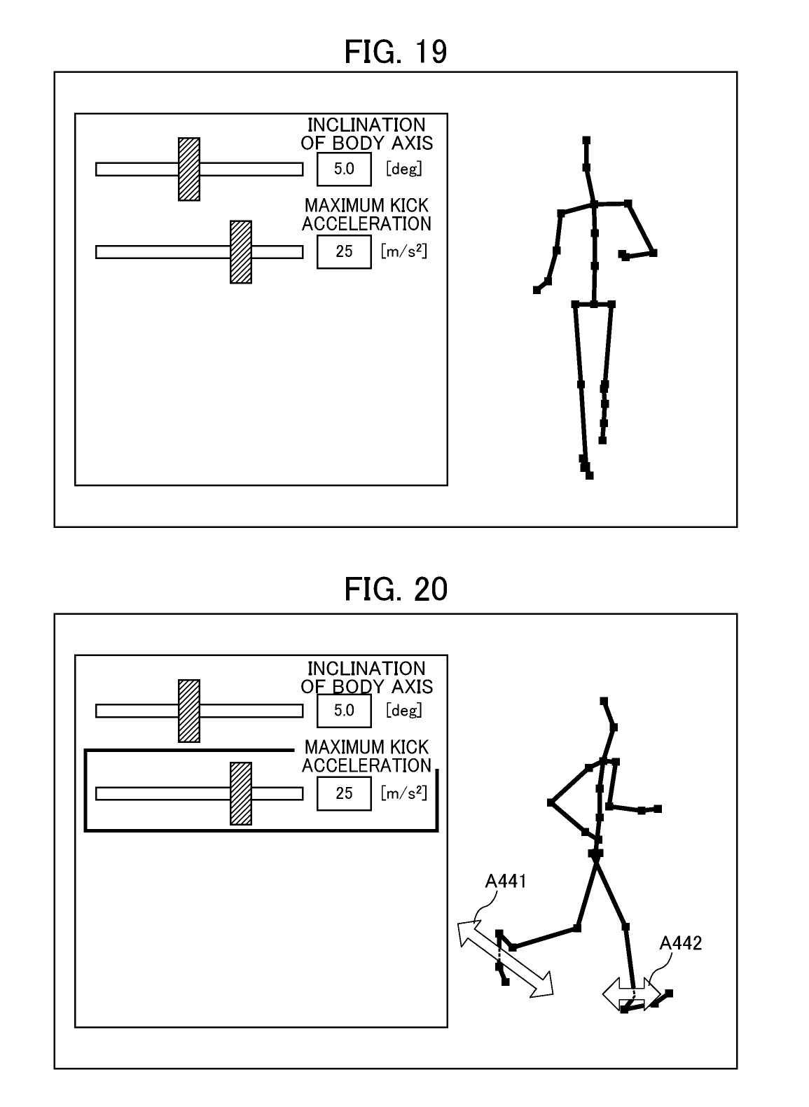

The first arrow drawing processing is started, for example, by performing an operation for selecting a value of the maximum kick acceleration via a click operation of the label of the maximum kick acceleration in the user interface while a skeleton is repeatedly drawn (refer to FIG. 19). At that time, a frame number (FrameNo) of a subject to be drawn and a value of the maximum kick acceleration are used as arguments and then first arrow drawing processing is called up.

When first arrow drawing processing starts, in Step S801, with respect to a selected index value regarding a motion, in the cases of the maximum and minimum index values at the time (FrameNo), the drawing processing unit 253 calculates a space posture of a skeleton (space position coordinates of a composite skeleton).

In Step S802, in the calculated skeleton space posture (the space position coordinates of the composite skeleton), the joints of the right ankle, the left ankle, the chest, the right wrist, and the left wrist are assigned as joints to be processed.

In Step S803, the drawing processing unit 253 determines a difference (vector) between joints to be processed for the respective skeleton space postures (the space position coordinates of the composite skeletons) in two index values that are the maximum and minimum.

In Step S804, the drawing processing unit 253 selects two joints having a large difference amount.

In Step S805, the drawing processing unit 253 generates an arrow where the difference amount is designated as “a length of the arrow” and the direction of the vector is designated as “a direction of the arrow.” Specifically, when, for example, the largest joint is the joint of the left ankle and the next largest joint is the joint of the right ankle, the drawing processing unit 253 draws arrows for the respective joints in which the difference amount is indicated as the length (or size) of the arrow and the difference direction is indicated as the direction of the arrow.

In Step S806, the drawing processing unit 253 performs a viewing point change to a viewing point allowing the determined difference between the joints to be processed to be clear by assigning the vertical direction from the ground as the axis. The viewing point direction is determined so that, for example, the direction of an arrow in a joint having the largest difference amount is parallel to the drawing plane (i.e., front viewing).

In Step S807, the drawing processing unit 253 controls the output unit 218 so as to draw the generated arrow on a corresponding joint.

Thereafter, the first arrow drawing processing ends.

FIG. 20 is a schematic view illustrating a display screen example where the viewing point direction has been changed.

In FIG. 20, the display screen example of FIG. 19 is changed to a state where the composite skeleton is viewed from the side, in which an arrow A441 in the joint of the left ankle and an arrow A442 of the joint of the right ankle are viewed from the front. In FIG. 20, a slide bar of a selected index value (a value of the maximum kick acceleration) regarding a motion and a region of a current set value are surrounded by a rectangular cursor.

Further, an index value regarding a motion changes with respect to every frame and therefore, the display screen example as illustrated in FIG. 20 changes with every time point.

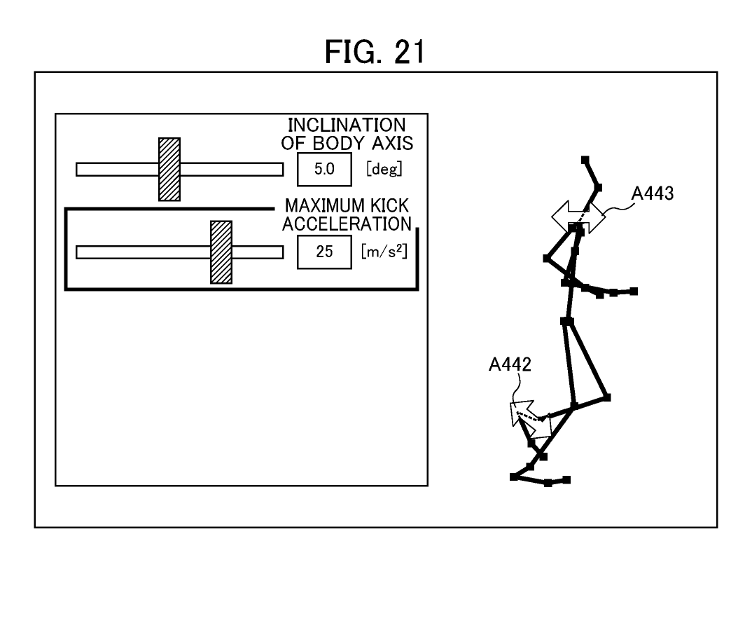

FIG. 21 is a schematic view illustrating a display screen example at a time different from that in FIG. 20.

In the display screen example illustrated in FIG. 21, arrows A442 and A443 are displayed for the joint of the right ankle and the joint of the chest, respectively.

In such a skeleton state, even when a value of the maximum kick acceleration changes, a position change of the joint of the left ankle is small and therefore, in the frame illustrated in FIG. 21, even when the slide bar of the maximum kick acceleration is operated, no arrow is displayed for the joint of the left ankle.

### [Second Arrow Drawing Processing]

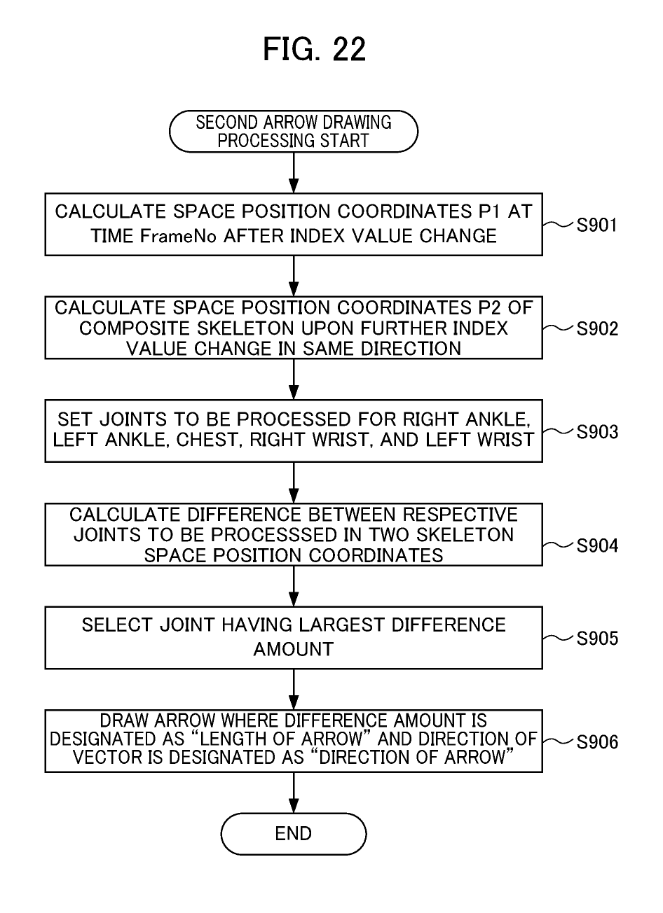

FIG. 22 is a flowchart illustrating a flow of second arrow drawing processing executed by the terminal apparatus 200 of FIG. 3 having the functional configuration of FIG. 5.

The second arrow drawing processing is processing for drawing an arrow indicating a changing direction of a site of a skeleton upon performing an operation for selecting an index value regarding a motion and then further changing the index value.

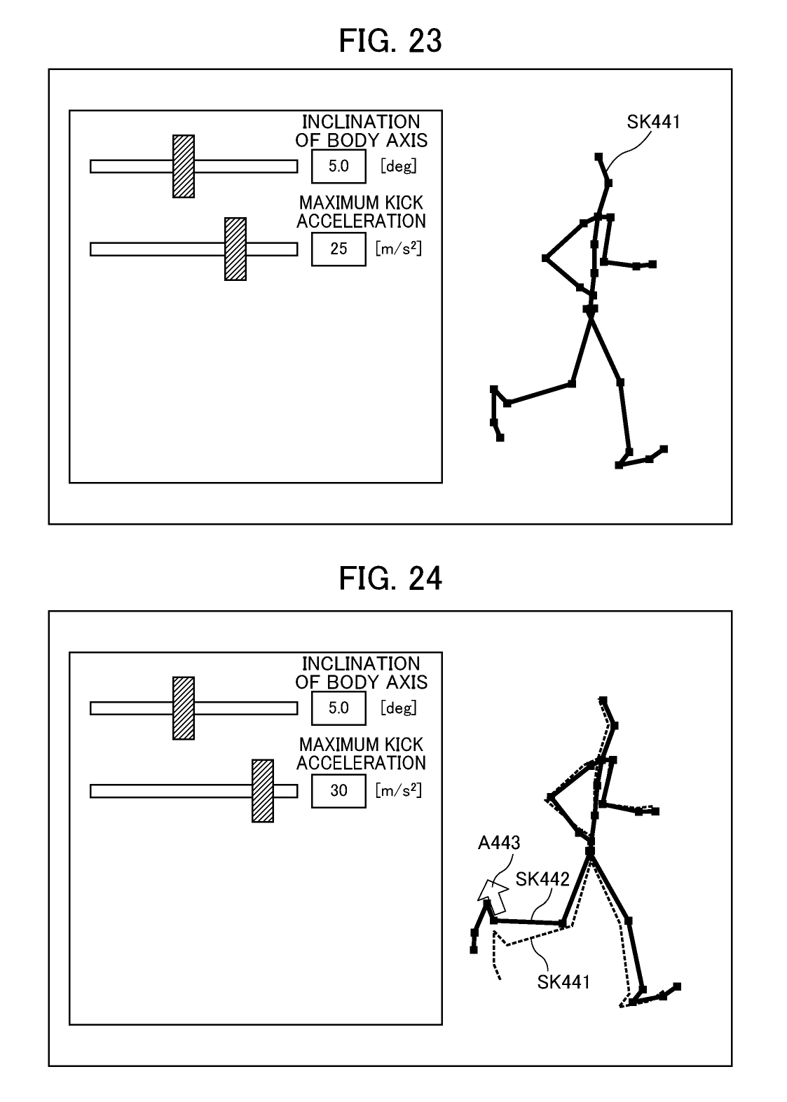

The second arrow drawing processing is started, for example, by performing an operation for selecting a value of the maximum kick acceleration via a click operation of the label of the maximum kick acceleration in the user interface while a skeleton is repeatedly drawn (refer to FIG. 23).

When second arrow drawing processing starts, in Step S901, the drawing processing unit 253 calculates space position coordinates P1 of a composite skeleton at a time (FrameNo) after an index value change.

In Step S902, the drawing processing unit 253 calculates space position coordinates P2 of the composite skeleton upon a further index value change in the same direction.

In Step S903, the drawing processing unit 253 sets the joints of the right ankle, the left ankle, the chest, the right wrist, and the left wrist as joints to be processed.

In Step S904, the drawing processing unit 253 determines a difference (vector) between respective joints to be processed using the skeleton space position coordinates P1 as a standard in the two skeleton space position coordinates. In other words, the drawing processing unit 253 calculates a difference of the space position coordinates P2 between joints to be processed when viewed from the space position coordinates P1.

In Step S905, the drawing processing unit 253 selects a joint having the largest difference amount.

In Step S906, the drawing processing unit 253 controls the output unit 218 so as to draw the arrow A443 on a corresponding joint, in which the difference amount is designated as “the size of the arrow” and the direction of the vector is designated as “the direction of the arrow.”

Thereafter, the second arrow drawing processing ends.

FIG. 24 is a schematic view illustrating a display screen example where the arrow A443 indicating a changing direction of a site of a skeleton is displayed.

In FIG. 24, the skeleton SK441 before an index value change in FIG. 23 is drawn by a dashed line and the skeleton SK442 after an index value change is drawn by a solid line. Further, in a joint vicinity of the right ankle of the skeleton motion SK442, there is displayed the arrow A443 indicating a changing direction of the right ankle when the index value is further changed.

In the display screen example illustrated in FIG. 24, the skeleton motion SK441 before an index value change may not always be drawn. The arrow A443 and the skeleton motion SK441 before an index value change disappear at a previously set time after an operation for changing the index value.

### [Index Reporting Processing]

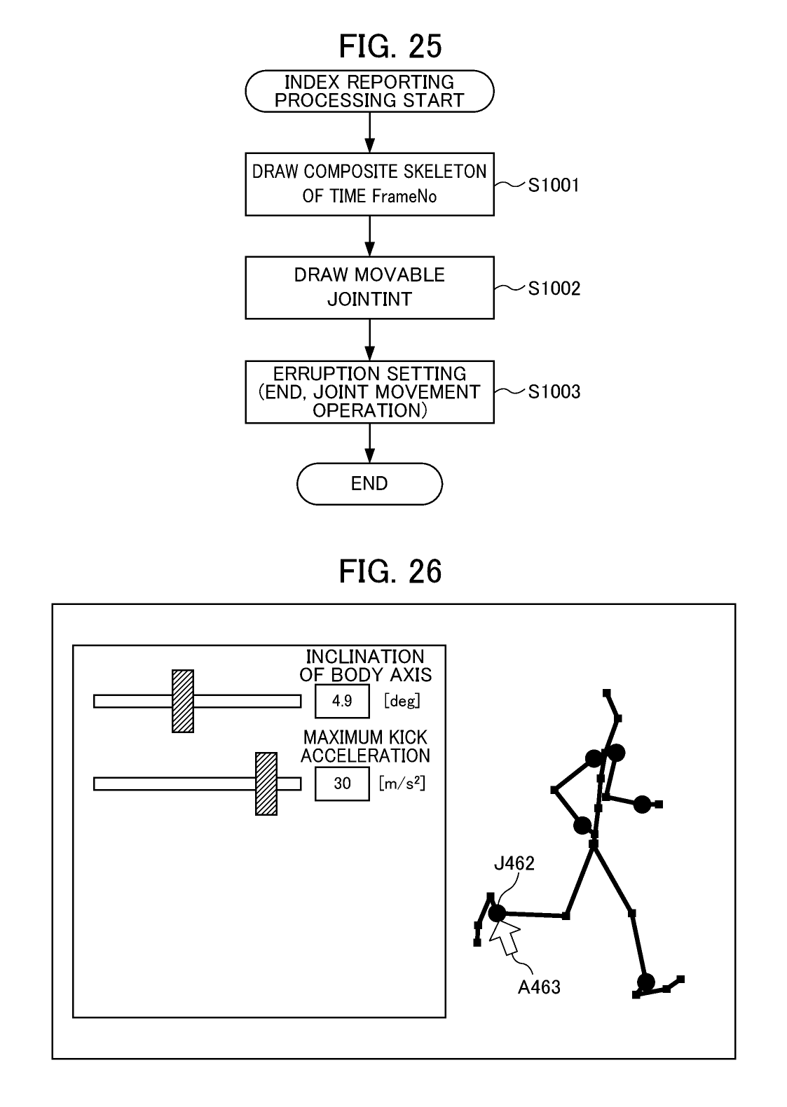

FIG. 25 is a flowchart illustrating a flow of index reporting processing executed by the terminal apparatus 200 of FIG. 3 having the functional configuration of FIG. 5.

The index reporting processing is processing for operating a still skeleton to report an index value changed in response to the operated site to the user.

The index reporting processing is started in response to a selection of a skeleton operation mode (a mode for receiving an operation of the user for a skeleton).

When index reporting processing starts, in Step S1001, the drawing processing unit 253 stops an automatic update of a frame of a skeleton motion and draws a skeleton while standing still at a frame number (FrameNo) selected by the user.

In Step S1002, the drawing processing unit 253 draws a movable joint using a large circle (refer to FIG. 26).

In Step S1003, the drawing processing unit 253 performs interruption setting for an end operation and interruption setting for a joint moving operation. In other words, there is set a state where an interruption signal indicating an end operation and an interruption signal indicating a joint moving operation are received.

After Step S1003, the drawing processing unit 253 moves to a standby mode.

FIG. 26 is a schematic view illustrating a display screen example of a skeleton a movable joint of which is drawn larger than other joints.

In the display screen example illustrated in FIG. 26, when the user has moved the movable joint on the screen (e.g., a joint J462 has been moved in the direction of an arrow A463 in FIG. 26), an interruption signal indicating a joint moving operation is generated and joint movement interruption processing is executed.

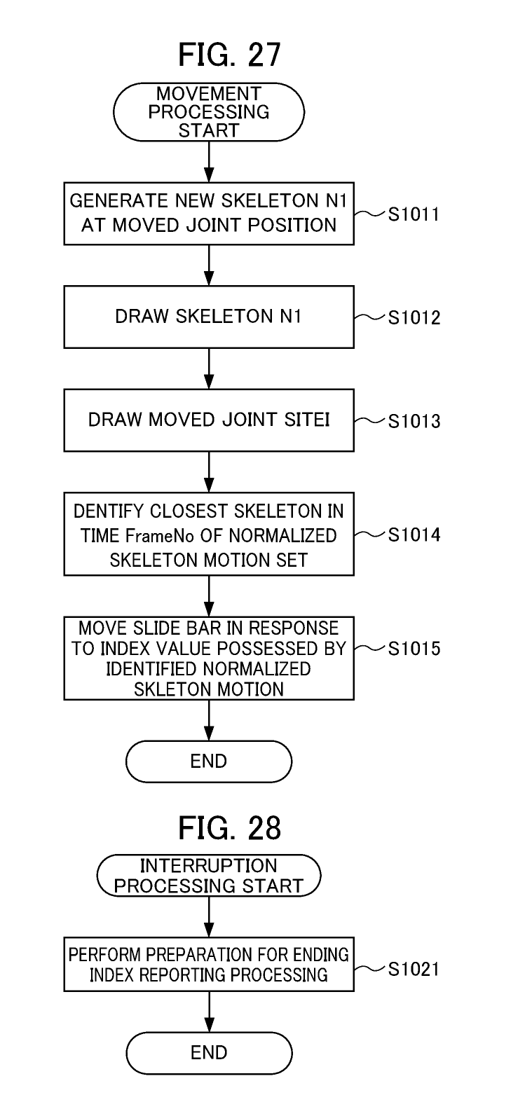

FIG. 27 is a flowchart illustrating a flow of movement processing executed as interruption processing in the index reporting processing.

When movement processing starts, in Step S1011, the drawing processing unit 253 generates a new skeleton N1 corresponding to a moved joint position. Even a movable joint is hard to freely move and therefore, a moving operation is allowable under a restriction where a bone is rigid.

In Step S1012, the drawing processing unit 253 draws the new skeleton N1.

In Step S1013, the drawing processing unit 253 draws a site of the moved joint for the following operation.

In Step S1014, the drawing processing unit 253 identifies a frame of a skeleton closest to the position of the moved joint from frames having a frame number of FrameNo in a set of the normalized skeleton motions acquired in the preparation. At that time, it is possible to perform a search by comparing motion parameters or to perform an identification after a conversion into space position coordinates.

In Step S1015, the drawing processing unit 253 moves the slide bar of the display screen in response to an index value possessed by the identified normalized skeleton motion.

In FIG. 26, index values corresponding to the skeleton after moved are displayed upon a movement of the joint J462 of the right ankle in the direction of the arrow A463.

After Step S1015, the drawing processing unit 253 moves to the standby mode again. Further, upon the standby mode in index reporting processing and movement processing, when an end operation is performed, an interruption signal indicating the end operation is generated and then end interruption processing is executed.

FIG. 28 is a flowchart illustrating a flow of processing executed as interruption processing in index reporting processing and movement processing.

When interruption processing starts, in Step S1021, a preparation (storage of necessary parameters, setting reset, and the like) for ending index reporting processing is executed.

After Step S1021, end interruption processing ends. Further, this also ends index reporting processing.

According to the embodiment, it is possible that, for example, the image generating apparatus 100 stores a standard skeleton configured based on motion capture data of a plurality of individuals acquired as samples and then the terminal apparatus 200 inputs a characteristic motion of the user of the terminal apparatus 200.

This makes it possible to generate a composite skeleton motion reflected with a motion of a specific individual from a standard skeleton motion obtained by integrating motions of a plurality of individuals.

In this case, there can be realized an embodiment, in which a service provider provides data of a standard skeleton motion and users using services generate composite skeleton motions reflected with respective motions of the users themselves.

As described above, the image generating system 1 of the present embodiment includes the image generating apparatus 100 and the terminal apparatus 200.

The image generating apparatus 100 includes the animation acquiring unit 150, and the animation acquiring unit 150 acquires a plurality of items of animation data.

The terminal apparatus 200 includes the index value acquiring unit 251, the composite skeleton generating unit 252, and the drawing processing unit 253.

The index value acquiring unit 251 inputs an index value regarding a motion of animation data, and then the composite skeleton generating unit 252 generates animation data (data of a composite skeleton motion) according to the index value input by the index value acquiring unit 251, using the plurality of items of animation data acquired by the animation acquiring unit 150.

Therefore, it is possible to change animation data (data of a skeleton) obtained by measuring a motion to a desired motion.

Further, the index value acquiring unit 251 inputs a plurality of index values regarding motions of animation data, and then the composite skeleton generating unit 252 generates animation data according to the plurality of index values input by the index value acquiring unit 251.

Therefore, it is possible that in animation data, index values regarding a plurality of motions are associated with each other and these index values each are changed, resulting in a possibility of realizing a change in a more complex motion.

Further, the image generating apparatus 100 includes the standard skeleton acquiring unit 152, and the standard skeleton acquiring unit 152 generates standard animation data associated with an index value regarding a motion from the plurality of items of animation data acquired by the animation acquiring unit 150. The composite skeleton generating unit 252 generates animation data according to the index value input by the index value acquiring unit 251, from the standard animation data.

Further, in the standard animation data, a standard value of an index regarding a motion is set, and the composite skeleton generating unit 252 generates animation data according to the index value input by the index value acquiring unit 251, based on the standard value (e.g., the upper or lower standard value) in the standard animation data.

Therefore, animation data where an index value regarding a motion has been changed can be generated based on an index value set based on a plurality of items of animation data obtained by measuring motions, and therefore, a change of a motion upon an index value change becomes based on a measured motion, resulting in a possibility of realizing a more appropriate motion change.

Further, the terminal apparatus 200 includes the drawing processing unit 253 causing the output unit 218 to display an animation based on standard animation data and a user interface for inputting an index value regarding a motion set for the animation data, and the index value acquiring unit 251 inputs an index value regarding a motion by operating the user interface.

Therefore, an index value regarding a motion can be input in a visually understandable form.

When the index value acquiring unit 251 has input an index value regarding a motion, the drawing processing unit 253 causes the output unit 218 to display an animation based on animation data generated by the composite skeleton generating unit 252 by discriminating a portion corresponding to the input index value.

Therefore, it is possible to display a changed portion of the animation based on a change of an index value regarding a motion in an easily understandable manner.

Further, the drawing processing unit 253 causes the output unit 218 to display a portion of an animation that changes according to an index value regarding a motion input by the index value acquiring unit 251 by discriminating the portion.

Therefore, a portion affected when an index regarding a motion has been changed can be displayed in an easily understandable manner.

Further, the drawing processing unit 253 causes the output unit 218 to display an index regarding a motion corresponding to animation data after inputting an index value regarding a motion by the drawing processing unit 251.

Therefore, an index regarding a motion can be changed according to a direct operation for an animation and therefore, operability upon performing a change for animation data can be enhanced.

### Modified Example

In the above-described embodiment, the slide bar in the display screen generated by an application inputs an index value regarding a motion.

In contrast, it is also possible to input an index value regarding a motion via a real-time motion to display a skeleton motion.

Specifically, it is possible that while an acceleration sensor is placed on a shoe of the user and a display apparatus (e.g., a mobile terminal) is placed on an arm, running is performed, and then an index value is input via an actual motion of the user to generate a skeleton motion.

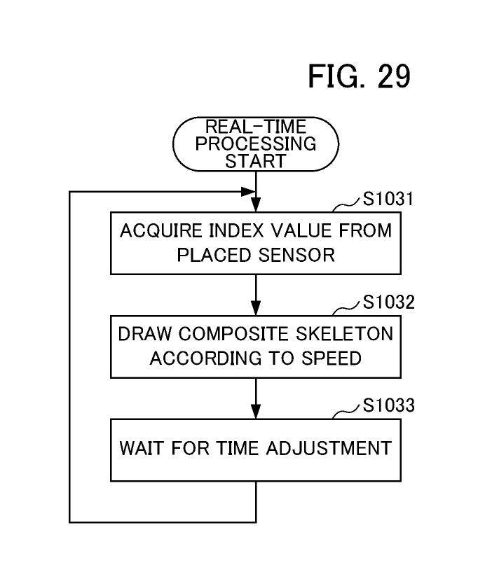

FIG. 29 is a flowchart illustrating a flow of real-time display processing executed by the terminal apparatus 200 of FIG. 3 having the functional configuration of FIG. 6.

The real-time display processing is processing for displaying a skeleton motion by inputting an index value regarding a motion in real time.

The real-time display processing is started in response to an input of the start of real-time display processing while an acceleration sensor is placed on a shoe of the user and the terminal apparatus 200 is placed on an arm.

When real-time display processing starts, in Step S1031, the terminal apparatus 200 acquires an index value regarding a motion from the acceleration sensor. For example, as an index value regarding a motion, speed information (information on a running speed) is acquired. The speed information can be acquired based on a preset stride by acquiring a running pitch from the acceleration sensor placed on the shoe. The speed information acquired by the acceleration sensor is transmitted to the terminal apparatus 200 via wireless communication.

In Step S1032, the terminal apparatus 200 draws, in the display screen, a composite skeleton according to a speed as an index value regarding a motion.

In Step S1033, the terminal apparatus 200 performs a wait for a time adjustment in real-time display processing.

Thereafter, real-time display processing is repeatedly executed.

Also upon displaying a skeleton motion by real-time display processing, it is presupposed that an axis parameter is set by preparation processing for an index used in displaying the skeleton motion.

Further, it is possible that in addition to the acceleration sensor placed on the shoe, a plurality of types of sensors is used and index values regarding a plurality of types of motions are acquired to display a composite skeleton according to the index values regarding the plurality of types of motions in real time. Also in this case, when data has been generated by preparation processing, a composite skeleton motion can be generated at low calculation cost.

It should be understood that the present invention is not limited to the above-described embodiments, and all modifications, improvements, and the like which come within the scope of achievement of the object of the present invention are embraced in the present invention.

In the embodiments, an index value set for a standard skeleton motion was determined from normalized skeleton motions of a population for generating the standard skeleton motion. In contrast, it is possible that an index value set for a standard skeleton motion is determined from a set of skeleton motions differing from the population generating the standard skeleton motion.

This makes it possible that even when data of normalized skeleton motions of a population for generating the standard skeleton motion is hard to use and in such other cases, an index value determined from another set of skeleton motions is set for the standard skeleton motion, resulting in a possibility of realizing the present invention more flexibly.

Further, in the embodiments, it is possible that a set of skeleton motions used for generating the standard skeleton motion includes either a plurality of items of motion capture data of a specific individual or motion capture data of a plurality of individuals.

Further, in the embodiments, the case where the image generating apparatus 100 applied with the present invention was configured using a server and the terminal apparatus 200 was configured using a smartphone was described as an example, but the present invention is not specifically limited thereto.

For example, the present invention can be realized using an electronic apparatus commonly used having an information processing function. Specifically, the image generating apparatus 100 and the terminal apparatus 200 can be configured, for example, using a notebook-type personal computer, a printer, a television receiver, a video camera, a mobile navigation apparatus, a mobile phone, a portable game machine, or the like

Further, in the embodiments, the case where the image generating apparatus 100 and the terminal apparatus 200 were configured as separate apparatuses was described as an example, but the present invention is not specifically limited thereto.

For example, it is possible that the image generating apparatus 100 is configured using a PC or the like and the image generating apparatus 100 includes the functions of the terminal apparatus 200 in the embodiments.

A series of processing described above can also be executed by either hardware or software.

In other words, the functional configurations of FIG. 4 and FIG. 6 are merely illustrative and the present invention is not specifically limited thereto. Further, in other words, the image generating apparatus 100 and the terminal apparatus 200 need only to include a function capable of executing a series of processing described above as a whole, and use of any type of function block to realize this function is not specifically limited to the examples of FIG. 4 and FIG. 6.

Further, one function block may be configured using either hardware alone or software alone, or by a combination thereof.

When a series of processing is executed by software, a program configuring the software is installed on a computer or the like from a network or storage medium.

As the computer, a computer incorporated in a dedicated hardware apparatus is also usable. Further, the computer may also be a computer capable of executing a variety of functions by installing a variety of programs, and, for example, a general-purpose personal computer is usable.

A storage medium including such programs is configured using the removable medium 131 of FIG. 2 or the removable medium 231 of FIG. 3 distributed separately from an apparatus body to provide the programs to the user, and using a storage medium and the like provided to the user by being previously incorporated in the apparatus body. The removable media 131 and 231 are configured, for example, using a magnetic disk (including a floppy disk), an optical disk, or a magneto-optical disk. The optical disk is configured, for example, using a CD-ROM (Compact Disk-Read Only Memory) or a DVD (Digital Versatile Disk). The magneto-optical disk is configured using a MD (Mini-Disk) or the like. Further, the storage medium provided to the user by being previously incorporated in the apparatus body is configured, for example, using the ROM 112 of FIG. 2 or the ROM 212 of FIG. 3 recorded with a program, or using a hard disk included in the storage unit 118 of FIG. 2 or the storage unit 219 of FIG. 3.

In the present specification, a step of describing a program recorded on a storage medium includes, needless to say, processings executed in a time-series manner according to the order of the step and also processings executed in parallel or individually even if the processings are not necessarily executed in a time-series manner.

Further, in the present specification, the terminology of the system means an entire apparatus including a plurality of apparatuses and a plurality of units.

Some embodiments of the present invention have been described, but these embodiments are merely illustrative and do not limit the technical scope of the present invention. It is possible that other various embodiments are employed in the present invention and further, various modifications such as omissions and substitutions are made without departing from the gist of the present invention. These embodiments and modifications are included in the scope and gist of the invention described in the present specification, and also are included in the scope of the invention described in the appended claims and the scope of equivalents thereof.

What is claimed is:

1. An image generating apparatus comprising:
a data acquiring unit for acquiring a plurality of items of animation data;
an input unit for inputting an index value regarding motion of animation data; and
a first generating unit for generating composite animation data according to the index value input by the input unit, using the plurality of items of animation data acquired by the data acquiring unit.

2. The image generating apparatus according to claim 1, wherein
the input unit inputs a plurality of index values regarding motion of the composite animation data and
the first generating unit generates the composite animation data according to the plurality of index values input by the input unit.

3. The image generating apparatus according to claim 1 further comprising a second generating unit for generating, from the plurality of items of animation data acquired by the data acquiring unit, standard animation data associated with an index value regarding motion,
wherein the first generating unit generates the composite animation data according to the index value input by the input unit from the standard animation data.

4. The image generating apparatus according to claim 3, wherein a standard value of the index regarding the motion is set for the standard animation data and
the first generating unit generates the composite animation data according to the index value input by the input unit, based on the standard value in the standard animation data.

5. The image generating apparatus according to claim 3 further comprising a display control unit for causing a display unit to display an animation based on the standard animation data and a user interface for inputting the index value regarding the motion,
wherein the input unit inputs the index value regarding the motion by operating the user interface.

6. The image generating apparatus according to claim 5, wherein when the input unit inputs the index value regarding the motion, the display control unit causes the display unit to display an animation based on the composite animation data generated by the first generating unit by discriminating a portion corresponding to the input index value.

7. The image generating apparatus according to claim 5, wherein the display control unit causes the display unit to display the portion of the animation that changes according to the index value regarding the motion input by the input unit by discriminating the portion.

8. The image generating apparatus according to claim 5, wherein the display control unit causes the display unit to display an index value corresponding to the composite animation data after inputting the index value regarding the motion by the input unit.

9. An image generating method comprising the steps of:
acquiring a plurality of items of animation data;
inputting an index value regarding a motion of animation data; and
generating composite animation data according to the index value input in the input step, using the plurality of items of animation data acquired in the data acquiring step.

10. A non-transitory storage medium encoded with a computer-readable program that enables a computer to execute functions as:
a data acquiring unit for acquiring a plurality of items of animation data;
an input unit for inputting an index value regarding motion of animation data; and
a generating unit for generating composite animation data according to the index value input by the input unit, using the plurality of items of animation data acquired by the data acquiring unit.
